(19) United States
(12) Patent Application Publication
(10) Pub. No.: US 2004/0043644 A1
(43) Pub. Date: Mar. 4, 2004

(54) Coaxial and linear power delivery devices

(76) Inventors: J. Ted DiBene II, Oceanside, CA (US); Edward J. Derian, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/447,301

(22) Filed: May 27, 2003

Related U.S. Application Data
(63) Continuation-in-part of application No. 10/132,586, filed on Apr. 25, 2002, now Pat. No. 6,623,279.
Application No. 10/132,586 is a continuation-in-part of application No. 09/801,437, filed on Mar. 8, 2001, now Pat. No. 6,618,268.
Application No. 09/801,437 is a continuation-in-part of application No. 09/432,878, filed on Nov. 2, 1999, now Pat. No. 6,356,448.

(51) Int. Cl. H01R 12/00

(52) U.S. Cl. 439/74

(57) ABSTRACT

A method, apparatus, and article of manufacture for distributing power to electronic circuits. The apparatus can include one or more power arrays and one or more ground arrays. The power arrays and the ground arrays are located within a single housing. Some embodiments further distribute signals to the electronic circuits. The arrays can be arranged in a linear or coaxial configuration.

### RELATED APPLICATIONS

This application is a continuation-in-part of U.S. patent application Ser. No. 10/132,586, titled Separable Coaxial Power Delivery Connection Methods, and filed on Apr. 25, 2002 which is a continuation-in-part of U.S. patent application Ser. No. 09/801,437, titled Method and Apparatus for Delivering Power to High Performance Electronic Assemblies, filed on Mar. 8, 2001 which is a continuation-in-part of U.S. patent application Ser. No. 09/432,878, titled Inter-Circuit Encapsulated Packaging for Power Delivery, filed on Nov. 2, 1999, now U.S. Pat. No. 6,356,448; all being hereby incorporated by reference in their entireties.

### BACKGROUND OF THE INVENTION

1. Field of the Invention

This invention relates to connection methods for providing electrical power and signals between two or more circuit boards, and in particular two methods and devices for improving the packaging and distribution of power and signals to high-performance electronic circuits.

2. Description of the Related Art

Increases in transistor density within complex electronics, such as microprocessors, has resulted in stringent power delivery requirements to these devices. High current slew-rates (dI/dt) in the power delivery path has forced the interconnection methods between the voltage regulation module and the microprocessor package to have very high performance. Often, the electronic device (or devices) are mounted on one printed circuit board (PCB) and the voltage regulation module is mounted on another. A board-to-board interconnection system is typically mounted between them where the power is delivered from one board to the another. The performance required of the interconnect usually entails that the connector has low inductance (low ‘L’ for high AC currents), low DC resistance (low ‘R_{DC}’ for high DC currents), a sufficient number of signal interconnects, a small form factor, and be of relatively low cost. It has often been the case that in order to achieve a low inductance, an interconnect required a large number of conductors. This was because many such interconnection systems were typically designed to be of general use—that is, for both DC power and signal interconnection. Additionally, when connectors were designed solely for power distribution they were almost exclusively designed to carry high DC currents and were not intended to be low inductance for high frequency AC currents as well. For example, typical pin and socket connectors are designed to handle high speed signals and are often spaced far apart relative to other signal pins, to maintain a particular impedance. This large spacing is not conducive to low inductance and small form factor and thus often results in a large connection system. Moreover such connectors often need to have sufficient spacing between the signals due to relatively high voltage potentials. Today, microprocessor and other device voltages have been reduced to near the 1 volt level which has negated the need, in many cases, for large spacing between contacts in these connection systems. Additionally, such connectors are often designed such that they consist of two independent connectors (two-piece) a male side and a female side. For power distribution this adds cost by necessitating that a connector be placed on both the upper and lower PCB. Furthermore, for power distribution, many of these connection systems require only small numbers of low-speed signals between the voltage regulation module and the microprocessor negating the need to support high frequency signal interconnections. Thus, it is seen that there is a need to address the aforementioned problems through an interconnection system that confronts the needs for high performance AC and DC power delivery, small form factor, signal interconnect, and low cost.

### SUMMARY OF THE INVENTION

The systems and methods of the present invention have several features, no single one of which are solely responsible for its desirable attributes. Without limiting the scope of this invention as expressed by the claims which follow, its more prominent features will now be discussed briefly. After considering this discussion, and particularly after reading the section entitled “Detailed Description of the Preferred Embodiments,” one will understand how the features of this invention provide several advantages to connection methods and systems.

One aspect is a connector suitable for electrically connecting a first printed circuit board to a second printed circuit board. The coaxial connector comprises a tubular housing having an inside surface, a first cylinder located adjacent to the inside surface and having an array of ground contacts with a first array of tabs extending therefrom, the array of ground contacts and the first array of tabs extend in substantially opposite directions, a second cylinder coaxially located within the first cylinder and having both an array of power contacts and a second array of tabs extending therefrom, the array of power contacts and the second array of tabs extend in substantially opposite directions from the second cylinder, and a dielectric ring located between the first cylinder and the second cylinder.

Another aspect is a linear connector configured to electrically connect a first printed circuit board to a second printed circuit board. The linear connector comprises a housing, a receptacle extending into the housing and having a first inside surface and a second inside surface, a portion of the first inside surface is substantially parallel to a portion of the second inside surface and a first linear ground array extending into the receptacle and located adjacent to the first inside surface, the first linear ground array having both a first array of ground contacts and a first array of tabs extending therefrom, the first array of ground contacts and the first array of tabs extend in substantially opposite directions from the first linear ground array. The connector further comprises a second linear ground array extending into the receptacle and located adjacent to the second inside surface, the second linear ground array having both a second array of ground contacts and a second array of tabs extending therefrom, the second array of ground contacts and the second array of tabs extend in substantially opposite directions from the second linear ground array and a linear power array extending into the receptacle and located between the first linear ground array and the second linear ground array, the linear power array having a first row of power contacts, a second row of power contacts, and a third array of tabs, all extending from the linear power array, the third array of tabs extending in substantially opposite directions from the first and second row of power contacts.

### BRIEF DESCRIPTION OF THE DRAWINGS

Referring now to the drawings in which like reference numbers represent corresponding parts throughout:

FIG. 1 is an isometric exploded view of a coaxial power/signal connector assembly.

FIG. 2 is an isometric assembly view of the coaxial power/signal connector assembly from FIG. 1.

FIG. 3 is a cutaway isometric assembly view of the coaxial power/signal connector from FIG. 2.

FIG. 4 is a cutaway isometric assembly view of the coaxial power/signal connector from FIG. 2 located between two printed circuit boards (PCB).

FIG. 5 is an isometric exploded view of a linear power connector assembly.

FIG. 6 is an isometric assembly view of the linear power connector from FIG. 5.

FIG. 7 is an isometric bottom view of the linear power connector from FIG. 6.

FIG. 8 is a cutaway isometric assembly view of the linear power connector from FIG. 6 located between two PCBs.

FIG. 9 is an isometric exploded view of a linear power/signal connector.

FIG. 10 is an isometric assembly view of the linear power/signal connector from FIG. 9.

FIG. 11 is an isometric exploded view of another embodiment of a linear power connector.

FIG. 12 is an isometric assembly view of the linear power connector from FIG. 11.

FIG. 13 is an isometric exploded view of another embodiment of a linear power connector.

FIG. 14 is an isometric assembly view of the linear power connector from FIG. 13.

FIG. 15 is a two-dimensional section view illustrating an architecture in which the present invention may be usefully employed in delivering power to a microprocessor.

FIG. 16 is a section view of a microprocessor package used in FIG. 15 which further illustrates the location of the power standoff assemblies associated with delivering power to the microprocessor shown in FIG. 15.

FIG. 17 is a conceptual isometric morphological progression of the coaxial power connector assembly into a linear power connector assembly.

### DETAILED DESCRIPTION OF THE PREFERRED EMBODIMENTS

These and other features, aspects and advantages of the present invention will now be described with reference to the drawings of several preferred embodiments which are intended to illustrate and not to limit the invention.

Coaxial Power/Signal Connector

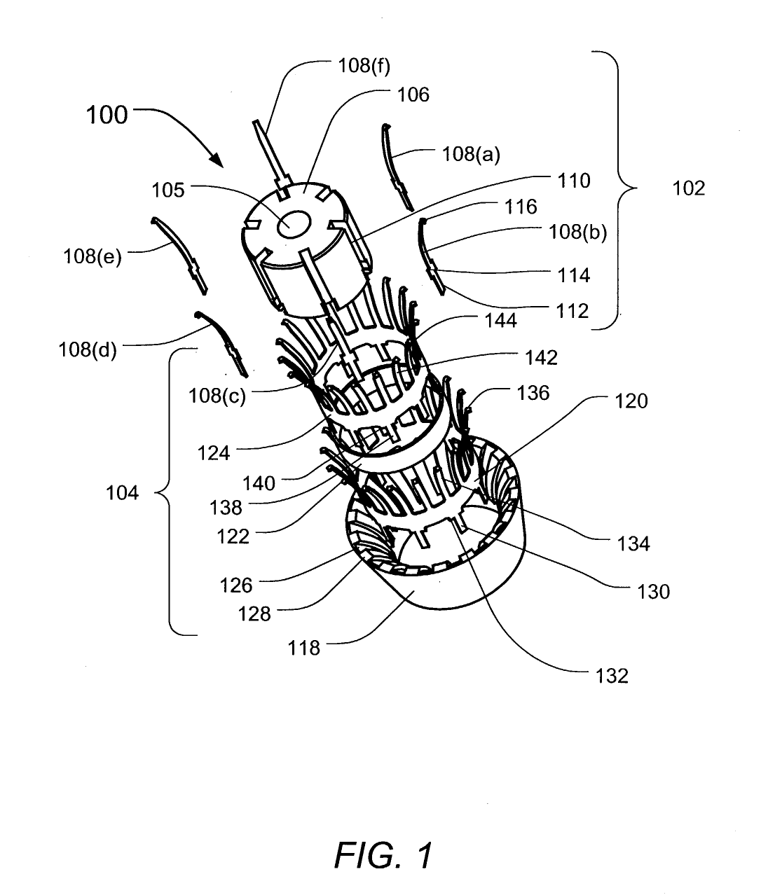

FIG. 1 is an isometric exploded view of a coaxial power and signal connector assembly 100. The coaxial power and signal connector assembly 100 includes an inner signal array subsection 102 and an outer power array subsection 104. The components of the inner signal array subsection 102 and the outer power array subsection 104 are illustrated as having cylindrical shapes. However, the inner signal array subsection 102 and the outer power array subsection 104 are not so limited. The inner signal array subsection 102 and the outer power array subsection 104 can have ellipsoid, parabolic, square, or other non-cylindrical geometric shapes.

In FIG. 1, the inner signal array subsection 102 has a cylindrical center body section 106. At both ends of the cylindrical center body section 106 are parallel surfaces. The parallel surfaces of the cylindrical center body section 106 can connect or engage with two mating parallel surfaces (not shown in FIG. 1). In one embodiment, these mating parallel surfaces are printed circuit boards (PCB). In this embodiment, a distance between the two parallel surfaces of the cylindrical center body section 106 is selected depending on the desired proximity between the two PCBs. Preferably, the desired proximity between the two PCBs is greater than the distance between the parallel surfaces of the cylindrical center body section 106.

Spaced around a circumference of the cylindrical center body section 106 are cavity sections 110. Each cavity section 110 extends between, and perpendicular to, the parallel surfaces located at the ends of the cylindrical center body section 106 to form a truncated rectangular channel therebetween. Each channel includes a bottom surface and two parallel sides. At least one of the parallel sides includes a retention feature. The retention feature limits the movement of, or retains, a signal contact 108(a)-(f) when the signal contact is inserted into the cavity section 110. Each signal contact 108(a)-(f) includes a tab section 112, a standoff section 114, and a contact region 116. The retention feature of the center body section 106 can be a ridge or step which engages with the standoff section 114 on the signal contact 108. The standoff section 114 can be in the form of a complimentary ridge or step which mates with the ridge or step in the cavity section 110. In the embodiment illustrated in FIG. 1, the cavity section 110 employs a ridge on both parallel sides of each channel. Each signal contact 108 in FIG. 1 employs a ridge that extends from opposite sides of the signal contact and in a direction towards the parallel sides of the channel. When a signal contact 108 is installed into the cavity section 110, the standoff section 114 can abut against the ridge in the cavity section 110 and/or against the PCB. More specifically, the standoff section 114 can butt up against the PCB. In this way, the standoff section 114 acts as a physical stop against the PCB for subsequent soldering. When the standoff section 114 abuts against the PCB, the surface of the PCB can also serve as a reference plane for controlling the height of the signal contact 108 with respect to the surface of the PCB. The inner signal array subsection 102 and the outer power array subsection 104 can similarly use the surface of the PCB as a reference plane. In this way, the relative heights of the inner signal array subsection 102, the outer power array subsection 104, and the signal contacts 108 with respect to the surface of the PCB can be the same. However, the relative heights need not be the same. Alternatively, the relative heights of the various contacts vary with respect to the surface of the PCB. Variations between these contacts may be advantageous depending on the mating PCBs. The standoff sections 114 can further hold the individual contacts in place during assembly into the cavity section 110 prior to assembly to the PCB.

In embodiments where the standoff section 114 engages against the mating ridge or step of the signal contact 108, the ridge or step of the cavity section 110 limits movement of the signal contact with respect to the center body section 106 in a direction towards one of the PCBs. Alternatively, the cavity section 110 tapers along at least a portion of the channel to engage and retain the signal contact 108.

Each signal contact 108 is generally a unitary linear member which conducts a signal between the parallel PCBs that mate with the parallel surfaces of the cylindrical center body section 106. One end of the signal contact 108 is the contact region 116 which forms a conductive pad surface. The conductive pad surface couples the signal contact 108 with the first of the two parallel PCBs. The portion of the signal contact between the contact region 116 and the standoff section 114 has a slightly curved shape. This curved shape allows the signal contact 108 to bend as the contact region 116 is brought in contact with the PCB. In this way, the PCB applies a compressive load to the contact region 116 which bends the portion of the signal contact located between the standoff section and the contact region 116. This bending occurs during assembly of the coaxial power and signal connector assembly 100 with the PCB. Moreover, minor relative movement of the PCB with respect to the coaxial power signal connector assembly 100 after the PCB is assembled with the coaxial power signal connector assembly will not cause the electrically connection between the contact region 116 and the PCB to be lost. Since the electrical connection between the contact region 116 and the PCB is not coupled in a permanent manner, the first PCB and coaxial power signal connector assembly 100 can be disassembled. In this way, the contact regions 116 are separable from the first PCB.

The tab section 112 or opposite end of the signal contact 108 couples to the second PCB. This coupling can be permanent in nature in that the second PCB and the signal contact can form a solder joint. For example, the tab section 112 could be press-fit soldered to the second PCB. Alternatively, the connection between the second PCB and the signal contact is a press-fit connection. With the tab section 112 contacting the second PCB, the signal contact 108 forms an electrical path between the first and second PCBs.

The outer power array subsection 104 includes an outer housing 118, a coaxial ground cylinder array 120, a ring 122, and a coaxial power cylinder array 124. The outer power array subsection 104 is assembled by concentrically locating the coaxial ground cylinder array 120, the ring 122, and the coaxial power cylinder array 124 within the outer housing 118. In a similar manner, the inner signal array subsection 102 is placed within the outer housing 118 to form the coaxial power and signal connector assembly 100. Alternatively, the ground cylinder array 120, the ring 122, and the power cylinder array 124 are not coaxial with one another and thus do not share the same central axis.

Alternatively, the electrical path through the coaxial ground cylinder array 120 and the coaxial power cylinder array 124 are reversed. In such an embodiment, the coaxial ground cylinder array 120 is used for power while the coaxial power cylinder array 124 is used for ground.

In one embodiment, the outer housing 118 and the ring 122 are formed of a dielectric material. The use of dielectric material allows the ring to contact the coaxial ground cylinder array and the coaxial power cylinder array without creating an electrical connection therebetween. Similarly, in embodiments where the outer housing 118 is made from a dielectric material, simultaneous contact with the coaxial ground cylinder array and the coaxial power cylinder array does not create an electrical connection therebetween.

The outer housing 118 can have a tubular shape. Once assembled, the coaxial ground cylinder array 120, the ring 122, and the coaxial power cylinder array 124 are located within an inner surface of the outer housing 118. The inner surface of the outer housing 118 has a tapering shape that includes convex and concave features on the inner surface. A convex feature is a curved or rounded outward portion of the inner surface. A concave feature is a hollowed or rounded inward portion of the inner surface. As illustrated in FIG. 1, these concave and convex features are alternately spaced around the inner surface of the outer housing 118. The concave features are in the form of grooves 126 in the inner surface. Located between two adjacent grooves 126 on the inner surface is the convex feature or land 128. The lands 128 extend in a direction parallel to the grooves 126. The concave features form valleys while the convex features form peaks or ridges around the inner surface of the outer housing 118. Together, the grooves 126 and lands 128 provide a bi-level curvilinear support on the inner surface of the outer housing 118 to control the mechanical actuation and travel of the coaxial ground cylinder array 120 and the coaxial power cylinder array 120. In this embodiment, the grooves 126 control the mechanical actuation and travel of the coaxial ground cylinder array 120. The lands 128 control the mechanical actuation and travel of the coaxial power cylinder array 124. Alternatively, the grooves 126 can control the mechanical actuation and travel of the coaxial power cylinder array 124 with the lands 128 controlling the mechanical actuation and travel of the coaxial ground cylinder array 120. In this way, the outer housing 118 encases both the coaxial power cylinder array 124 and the coaxial ground cylinder array 120.

The coaxial ground cylinder array 120 includes tab sections 130, ground standoff sections 132, ground contacts or beams 134, and ground contact points 136. The coaxial ground cylinder array 120 has a ring like body with the beams 134 and tab sections 130 extending in substantially opposite directions therefrom. The beams 134 follow a curvilinear path and extend in a direction towards the first PCB. The tab sections 130 follow a linear path and extend in the opposite direction towards the second PCB. As with the signal contacts 108 previously described, this curved shape allows the beams 134 to bend as the ground contact points 136 on the ends of the beams are brought in contact with the first PCB. In this way, the first PCB applies a compressive load to the contact points 136 which bends the beams 134. This bending occurs during assembly of the coaxial power and signal connector assembly 100 with the first PCB. Since the electrical connection between the contact points 136 and the first PCB is not coupled in a permanent manner, the first PCB and coaxial power signal connector assembly 100 can be disassembled. In this way, the contact points 136 are separable from the first PCB.

The tab sections 130 couple to the second PCB. This coupling can be permanent in nature in that the second PCB and the coaxial ground cylinder array 120 can form a solder joint. For example, the tab section 130 could be press-fit soldered to the second PCB. Alternatively, the connection between the second PCB and the coaxial ground cylinder array 120 is a press-fit connection. With the tab sections 130 contacting the second PCB, the coaxial ground cylinder array 120 forms an electrical path between the first and second PCBs.

The beams or ground contacts 134 fit within the grooves 126 in the outer housing 118. The beams 134 are free to move into and out of the grooves 126 in response to pressure being applied to the ground contact points 136. However, the depths of the grooves 126 limit the maximum travel of the beams 134. Similarly, the widths of the grooves 126 can limit movement of the beams 134 in a direction towards the adjacent lands 128. For example, when adequate pressure is applied to the ground contact points 136 so that the beams 134 are in the grooves 126, side to side movement of the beams 134 is limited by the adjacent lands 128. In this way, the grooves 126 limit the actuation and travel of the ground contacts 134 during assembly of the coaxial power and signal connector assembly 100 with the first PCB. Alternatively, the curve of the beams 134 of the coaxial ground cylinder array 120 is increased so that the beams fall within the grooves 126 when the beams are in an uncompressed state.

The ground standoff sections 132 create landing zones or ridges at the intersections of the tab sections 130 with the ring like body of the coaxial ground cylinder array 120. These landing zones increase the width of the tab sections 130 at the intersection of the tab sections with the ring like body so that when the coaxial ground cylinder array 120 is inserted into the second PCB, a correct insertion depth is maintained. This correct insertion depth of the tab section 130 is achieved when the ridges or landing zones rest upon the surface of the second PCB.

The ring 122 slides within the inside diameter of the coaxial ground cylinder array 120. When the ground cylinder array 120 and the coaxial power cylinder array 124 are both installed within the outer housing 118, the ring 122 can provide electrical isolation between the ground cylinder array and the coaxial power cylinder array. The ring 122 illustrated in FIG. 1 extends for 360 degrees. However, the ring 122 can extend for less than 360 degrees around the inside diameter of the coaxial ground cylinder array 120 and still provide electrical isolation. Moreover, the ring 122 can be a unitary or multi-piece ring.

The coaxial power cylinder array 124 includes tab sections 138, power standoff sections 140, power contacts or beams 142, and power contact points 144. The coaxial power cylinder array 124 has a ring like body with the beams 142 and tab sections 138 extending in substantially opposite directions therefrom. The beams 142 follow a curvilinear path and extend in a direction towards the first PCB. The tab sections 138 follow a linear path and extend in the opposite direction towards the second PCB. As with the signal contacts 108 previously described, this curved shape allows the beams 142 to bend as the power contact points 144 on the ends of the beams are brought in contact with the first PCB. In this way, the first PCB applies a compressive load to the contact points 144 which bends the beams 142. This bending occurs during assembly of the coaxial power and signal connector assembly 100 with the first PCB. Since the electrical connection between the contact points 144 and the first PCB is not coupled in a permanent manner, the first PCB and coaxial power signal connector assembly 100 can be disassembled. In this way, the contact points 144 are separable from the first PCB.

The tab sections 138 couple to the second PCB. This coupling can be permanent in nature in that the second PCB and the coaxial power cylinder array 124 can form a solder joint. For example, the tab section 138 could be press-fit soldered to the second PCB. Alternatively, the connection between the second PCB and the coaxial power cylinder array 124 is a press-fit connection. With the tab sections 138 contacting the second PCB, the coaxial power cylinder array 124 forms an electrical path between the first and second PCBs.

The beams or ground contacts 142 slidingly engage the lands 128 in the outer housing 118. The beams 142 are free to move towards and away from the lands 128 in response to pressure being applied to the power contact points 144. However, the lands 128 limit the maximum travel of the beams 142. In this way, the lands 128 limit the actuation and travel of the power contact points 144 during assembly of the coaxial power and signal connector assembly 100 with the first PCB. The widths of the beams 142 can be selected to prevent the beams 142 from contacting the beams 134 which are aligned with the adjacent grooves 126.

The ground standoff sections 140 create landing zones or ridges at the intersections of the tab sections 138 with the ring like body of the coaxial power cylinder array 124. These landing zones increase the width of the tab sections 138 at the intersection of the tab sections with the ring like body so that when the coaxial power cylinder array 124 is inserted into the second PCB, a correct insertion depth is maintained. This correct insertion depth of the tab section 138 is achieved when the ridges or landing zones rest upon the surface of the second PCB.

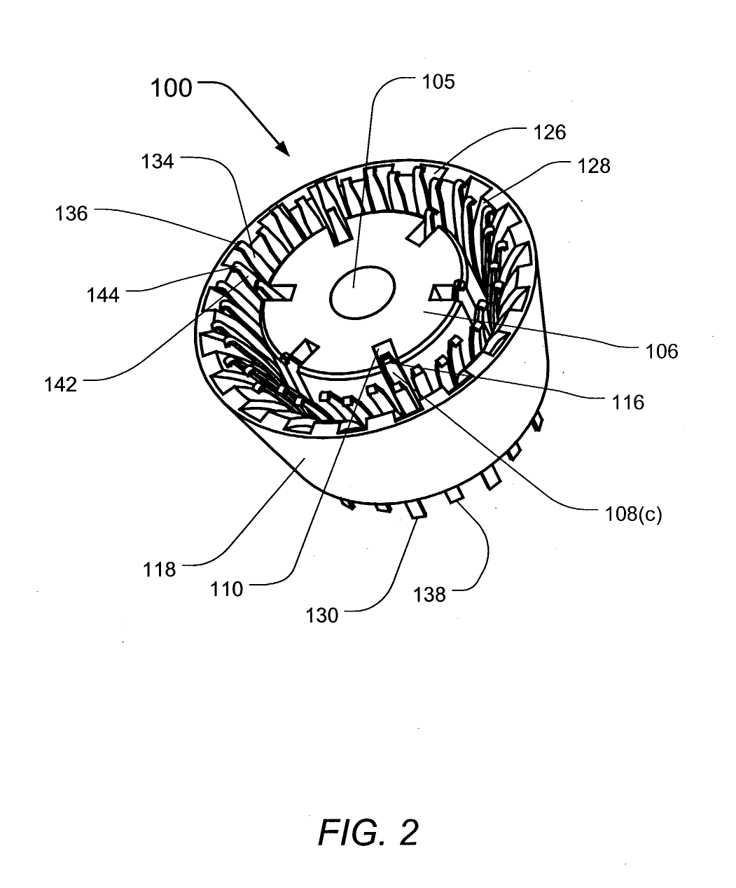

FIG. 2 is an isometric assembly view of the coaxial power signal connector 100 from FIG. 1. With reference to FIGS. 1 and 2, the coaxial power signal connector 100 is assembled by inserting the inner signal array subsection 102 into the outer power array subsection 104 as shown in FIG. 2. Once assembled, the coaxial power signal connector 100 forms a unitary compact assembly. Alternatively, the coaxial power signal connector includes combinations of one or more ground cylinder arrays 120 and one or more power cylinder array 124. For example, the coaxial power signal connector 100 can include two power cylinder arrays 124 and two ground cylinder arrays 120, each arranged coaxially. In such an embodiment, one or more rings 122 can separate the power and grounds arrays.

As shown, the signal contacts 108 are installed into the cavity sections 110 of the center body section 106. Signal contact 108(c) is an exemplary signal contact identified in FIG. 2. The center body section 106 provides mounting and electrical isolation between the signal contact 108(c), the adjacent power contacts 142, the ground contacts 134, and other signal contacts 108. As shown, the signal contacts 108 are located adjacent to, but are not in contact with, the coaxial power cylinder array 124 (see FIG. 1) and the coaxial ground cylinder array 120 (see FIG. 1). In some embodiments, the signal contacts 108 and the cavity sections 110 have an interference fit. This interference fit holds the signal contacts 108 within the cavity sections 110 when the coaxial power and signal connector assembly 100 is not attached to the mating PCBs. Once mated to the PCBs, the signal contacts 108 are fixedly attached to the PCBs. In FIG. 2, the standoff section 114 (see FIG. 1) can abut against the ridge in the cavity section 110 and/or against the PCB. Once engaged with the mating ridge or step of the signal contact 108, the ridge or step of the cavity section 110 limits movement of the signal contact with respect to the center body section 106 in a direction towards one of the PCBs. The center body section 106 retains the signal contacts 108 and prevents shorting to other signal contacts and cylinder arrays 120, 124.

Upon assembly, the ground contacts 134 and power contacts 142 are arranged in an inter-digitated manner in the coaxial power and signal connector assembly 100. Inter-digitated means at least one ground contact 134 is located between two power contacts 142 or at least one power contact is located between two ground contacts around the inner surface of the outer housing 118. By inter-digitating the power contacts 142 and the ground contacts 134, the impedance and inductance for the power/ground portion of the coaxial power and signal connector assembly 100 is reduced.

In the embodiment illustrated in FIG. 2, the coaxial power cylinder array 124 has a smaller diameter than the coaxial ground cylinder array 120. The power contacts 142 are located at a different distance from the center body section 106 than the ground contacts 134 are from the center body section. In the embodiment shown in FIG. 2, the ground contacts 134 are at a greater distance from the center body section 106 than the power contacts 142. However, the power contacts and the ground contacts can actuate a similar distance in a direction towards the bi-level curvilinear support on the inner surface of the outer housing 118.

During assembly, the grooves 126 provide support for the ground contacts 134 as the ground contact points 136 are compressed against the first PCB. The lands 128 provide support for the power contacts 142 as the power contact points 144 are compressed against the first PCB. Once assembled with the first and second PCBs, the ground contacts 134 and the power contacts 142 each contact the first PCB around different coaxial and circular contact regions. The ground contacts 134 contact the first PCB substantially along a first circular region on the first PCB. The power contacts 142 contact the first PCB substantially along a second circular region that is coaxial with the first circular region. In the embodiment of FIG. 2, the second circular region is located within the first circular region. However, it need not be so. The power contacts 142 could be aligned with the grooves 126 while the ground contacts are aligned with the lands 128. Continuing with this embodiment, the power contacts could actuate a greater distance than the ground contacts before the power contacts contact the grooves and the ground contacts contact the lands. Alternatively, the beams 134 for the power contacts 142 can have a greater curvature than the beams 132 for the ground contacts 134. In this alternate embodiment, power contacts 142 and the ground contacts could actuate similar distances towards the grooves 126 and the lands 128, respectively.

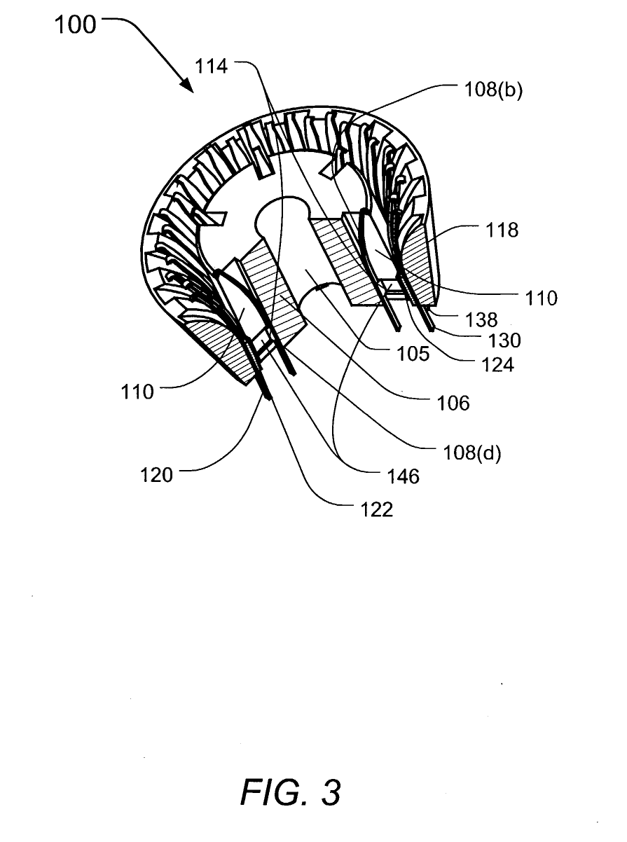

FIG. 3 is a cutaway isometric assembly view of the coaxial power/signal connector 100 from FIG. 2. The cutaway section cuts through the coaxial power/signal connector 100 through two grooves 126 in the inner surface of the outer housing 118 and two signal contacts 108(d), 108(b). Spaced around the outer circumference of the cylindrical center body section 106 are the cavity sections 110. Each cavity section 110 forms a truncated rectangular channel. Each channel includes a bottom surface and two parallel sides. As shown, the side adjacent to the signal contact 108(d) and the side adjacent to the signal contact 108(b) each include a ridge or step 146 retention feature. The ridges or steps 146 engage with the standoff section 114 or complimentary ridge or step on each the signal contacts 108 which then mates with the ridge or step in the cavity section 110. Once engaged, the ridge or step 146 limits the movement of, or retains, the signal contacts 108(b), 108(d) when the signal contact is inserted into its respective cavity section 110. Alternatively, the cavity section 110 tapers along at least a portion of the channel to engage and retain the signal contact 108.

In FIG. 3, the exemplary signal contact 108(d) is mounted in the center body section 106 and adjacent to the coaxial ground cylinder array 120 and the coaxial power cylinder array 124. In this way, the signal contacts 108 are both mechanically and electrically isolated from the coaxial power cylinder array 124 and the coaxial ground cylinder array 120.

The ring 122 mechanically and electrically isolates the coaxial power cylinder array 124 from the coaxial ground cylinder array 120. In one embodiment, the ring 122 is made from a dielectric material. The tabs 130, 138 are arranged in an inter-digitated fashion with one another. Inter-digitated means at least one tab 130 is located between two tabs 138 or at least one tab 138 is located between two tabs 130 around the inner surface of the outer housing 118 adjacent to the second PCB. By inter-digitating the tabs 138 of the coaxial power cylinder array 124 and the tabs 130 of the coaxial ground cylinder array 120, the impedance and inductance for the power/ground portion of the coaxial power and signal connector assembly 100 is reduced. Inter-digitating the tabs 130, 138 and the beams 134, 142 can further reduce the impedance and inductance for the power/ground portion of the coaxial power and signal connector assembly 100.

Referring to FIGS. 1 and 3, the number of beams 142 and the number of tabs 138 in the coaxial power cylinder array 124 are different. In the embodiment illustrated in FIGS. 1 through 3, the ratio of beams 142 to tabs 138 is 2:1. However, this need not be so. The ratio of beams 142 to tabs 138 could be 1:1 in another embodiment. In still another embodiment, the number of tabs is greater than the number of beams. Likewise, the number of beams 134 and the number of tabs 130 in the coaxial ground cylinder array 120 are different. In the embodiment illustrated in FIGS. 1 through 3, the ratio of beams 134 to tabs 130 is 2:1. However, this need not be so. The ratio of beams 134 to tabs 130 could be 1:1 in another embodiment. In addition, the ratio of tabs to beams for the coaxial ground cylinder array 120 could be different than the ratio of tabs to beams for the coaxial power cylinder array 124.

Referring to the embodiment of FIGS. 1 and 3, the tabs 138 and the beams 142 extend in opposite directions from the coaxial power cylinder array 124. The tabs 138 extend from the coaxial power cylinder array 124 at points spaced around the coaxial power cylinder array. The beams 142 extend from the coaxial power cylinder array 124 at points spaced around the coaxial power cylinder array. However, the points from where the tabs 138 extend from and the point from where the beams 142 extend from do not coincide. The points associated with the tabs 138 are located between the points that are associated with the beams 142. In this way, the beams 142 and the tabs 138 are askew from one another. However, this need not be so. In one embodiment, the points for the tabs 138 are aligned with the points for the beams. Alternatively, the points for the tabs 138 and the points for the beams 142 are askew with the points associated with the beams 142 being located between the points that are associated with the tabs 138. Further, as discussed above, the ratio of tabs 138 to beams 142 can also vary among different embodiments.

Still referring to the embodiment of FIGS. 1 and 3, the tabs 130 and the beams 134 extend in opposite directions from the coaxial ground cylinder array 120. The tabs 130 extend from the coaxial ground cylinder array 120 at points spaced around the coaxial ground cylinder array. The beams 134 extend from the coaxial ground cylinder array 120 at points spaced around the coaxial ground cylinder array. The points associated with the tabs 130 are aligned with the points that are associated with the beams 134. In this way, the beams 134 and the tabs 130 are inline with one another. However, this need not be so. In one embodiment, one or more of the points for the tabs 130 are not aligned with the points for the beams 134. In these embodiments, the points for the tabs 130 could be located between the points for the beams 134 or the points for the beams 134 could be located between the points for the tabs 130. Further, as discussed above, the ratio of tabs 130 to beams 134 can also vary among different embodiments.

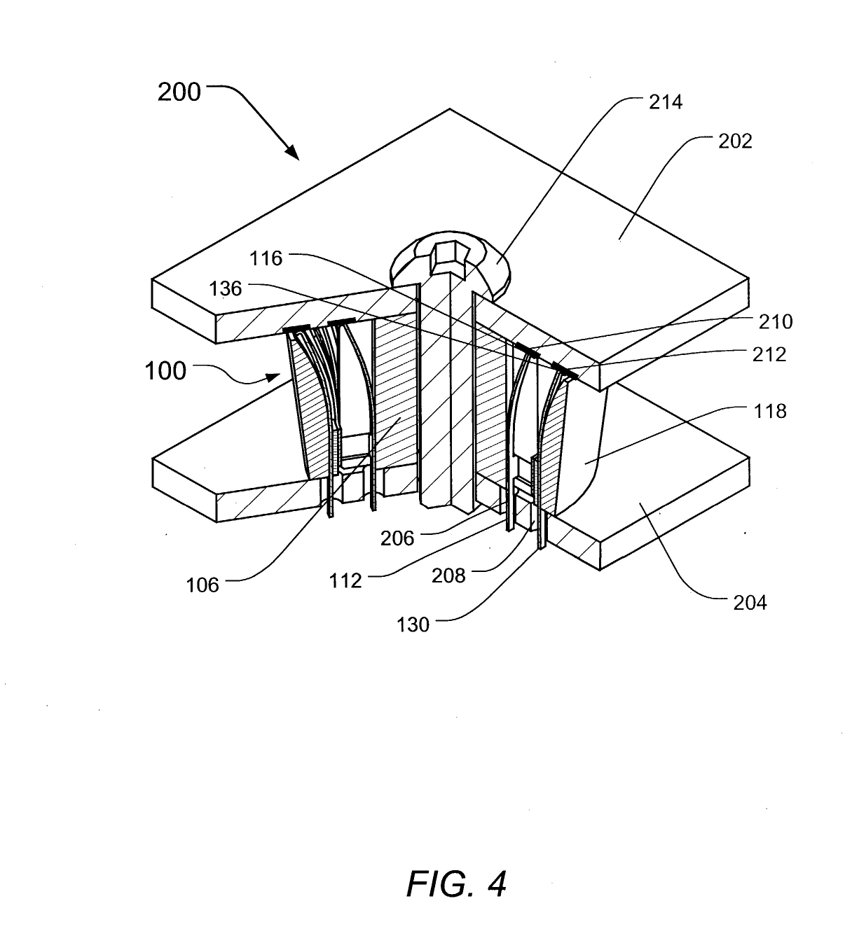

FIG. 4 is a cutaway isometric assembly view of the coaxial power signal connector 100 from FIG. 2 located between a first printed circuit board and a second printed circuit board thereby forming a PCB and connector assembly 200.

The PCB and connector assembly 200 includes a coaxial power and signal connector assembly 100, a first PCB assembly 202, a second PCB assembly 204, and a fastener 214. In the embodiment illustrated in FIG. 4, the coaxial power and signal connector assembly 100 is easily separated from the first PCB assembly 202 via the fastener 214. In contrast, the coaxial power and signal connector assembly 100 is not separable from the second PCB assembly 204.

The coaxial power and signal connector assembly 100 is mounted between the first PCB assembly 202 and the second PCB assembly 204. In one embodiment, one end of the coaxial power and signal connector assembly 100 is first fixedly attached to the second PCB assembly 204. Then, the first PCB assembly 202 is brought into mating contact with the opposite end of the coaxial power and signal connector assembly 100. The fastener 214 maintains the mating contact between the coaxial power and signal connector assembly 100 and the first PCB assembly 202. Alternatively, one end of the coaxial power and signal connector assembly 100 is initially and temporarily assembled to the second PCB assembly 204. The first PCB assembly 202 is then brought into mating contact with the coaxial power and signal connector assembly 100. The fastener 214 maintains the mating contact between the first PCB assembly 202 and the second PCB assembly 204. The coaxial power and signal connector assembly 100 is then permanently attached to the second PCB assembly 204, via, for example, solder.

Depending on the embodiment, the fastener 214 can apply a compressive load to the PCB and connector assembly 200 via engagement with the coaxial power and signal connector assembly 100 and the first PCB assembly 202 or via engagement with the first and second PCB assemblies 202, 204. In one embodiment, the fastener 214 couples the first PCB assembly 202 to the second PCB assembly 204. This could be accomplished by, for example, allowing the fastener 214 to pass through but not engage the coaxial power and signal connector assembly 100. In this embodiment, the fastener 214 applies a compressive load to the coaxial power and signal connector assembly 100 via engagement with the first and the second PCB assemblies 202, 204. The engagement with the first and second PCB assemblies 202, 204 can be accomplished by, for example, the head of the fastener 214 bearing on the surface of the first PCB assembly 202 with the other end of the fastener engaging threads in the second PCB assembly 204. Alternatively, the fastener 214 includes a second head on the opposite end of the fastener which bears on a surface of the second PCB assembly 204. In this embodiment, the compressive load is still achieved without the fastener 214 engaging threads in the second PCB assembly 204.

Alternatively, the fastener 214 couples the first PCB assembly 202 to the coaxial power and signal connector assembly 100. In this embodiment, the fastener 214 applies a compressive load to the first PCB assembly 202 via engagement with the first PCB assembly and the coaxial power and signal connector assembly 100. In this embodiment, the fastener 214 is not required to engage with the second PCB assembly 204 since the fastener engages with the coaxial power and signal connector assembly 100. The engagement with the first PCB assembly 202 and the coaxial power and signal connector assembly 100 can be accomplished by, for example, the head of the fastener 214 bearing on the surface of the first PCB assembly 202 with threads on the body of the fastener engaging threads in the coaxial power and signal connector assembly 100. The compressive load is achieved without the fastener 214 engaging with the second PCB assembly 204. Embodiments, where the fastener 214 engages with one or more of the first and second PCB assemblies 202, 204 and the coaxial power and signal connector assembly 100 is also contemplated and is clearly an aspect of the invention.

The first PCB assembly 202 includes contact pads 212 and contact signal pads 210 located on the underside of the first PCB assembly 202. The contact pads 212 include power contacts (not shown) and ground contacts (not shown). The power contacts and the ground contacts are arranged in a circle on the surface of the PCB. This arrangement aligns the power contacts on the PCB with the power contacts 142 and aligns the ground contacts on the PCB with the ground contacts 134. In this way, each of the contact pads 212 individually mates with a power contact 142 or a ground contact 134. The contact signal pads 210 mate with the signal contacts 108(A)-(F).

Fastener 214, which may be a screw or some other mechanical fastener, is secured to the lower PCB 204. The fastener 214 can be secured to a retention device located within the lower PCB 204 or located on the backside of the lower PCB assembly 204. In this way, the fastener compresses the upper PCB assembly 202 against the power contacts 142, the ground contacts 134, and the signal contacts 108 of the coaxial power and signal connector assembly 100. The power contacts 142, the ground contacts 134 and the signal contacts 108 are compressed to a known height and set by the center body section 106 of the coaxial power and signal connector assembly 100. The travel of the power contacts 142 and the ground contacts 134 is further limited by the curvilinear supports 126, 128. As shown in FIG. 4, the center body section 106 contacts both the first PCB assembly 202 and the second PCB assembly 204. However, contact between center body section 106 and one or more of the PCBs is not required as long as the power contacts 142, the ground contacts 134, and the signal contacts 108 are in contact with the upper PCB assembly 202.

The second PCB assembly 204 includes plated through holes 206, 208. The plated through holes 206, 208 are configured to receive the tabs of the power contacts 142, the ground contacts 134, and the signal contacts 108. In the illustrated embodiment, the plated through holes 206 are arranged in a circle on the surface of the second PCB assembly 204 and sized to receive the tabs 112 of the signal contacts 108. There are six plated through holes 206 in the circle. Each hole receives one of the six signal contacts 108(a)-(f).

The plated through holes 208 are arranged in first and second concentric circles on the surface of the second PCB assembly 204. The plated through holes 208 for the first concentric circle are aligned and sized for receiving the tabs 130 (see FIG. 1) from the coaxial ground cylinder array 120. The plated through holes 208 for the second concentric circle are aligned and sized for receiving the tabs 138 (see FIG. 1) from the coaxial power cylinder array 124. Alternatively, a single circle of plated through holes 208 are arranged on the second PCB to receive both tabs 130, 138. In this embodiment, the size of the holes is increased to receive either tab 130, 138.

Alternate embodiments of the coaxial power signal connector 100 fall within the scope of the invention. For example, the signal contacts 108(A)-(F) as shown in FIG. 2 may alternatively be placed in other locations within the coaxial power and signal connector assembly 100. For example, the signal contacts 108 could be located on a circumference of the coaxial power cylinder array 124 and the coaxial ground cylinder array 120. In this embodiment, the coaxial power cylinder array 124 could be split and expanded to accommodate one or more of the signal contacts 108. Alternatively, a portion of the coaxial power cylinder array 124 could be removed, thereby creating a space around its circumference for the insertion of the signal contact 108. A similar accommodation could be made around the circumference of the coaxial ground cylinder array 120 to incorporate one or more of the signal contacts 108. Moreover, additional cylinder arrays may be added to the coaxial power and signal connector assembly 100 as necessary to further enhance the applicability of the invention.

Linear Power and Power/Signal Connector

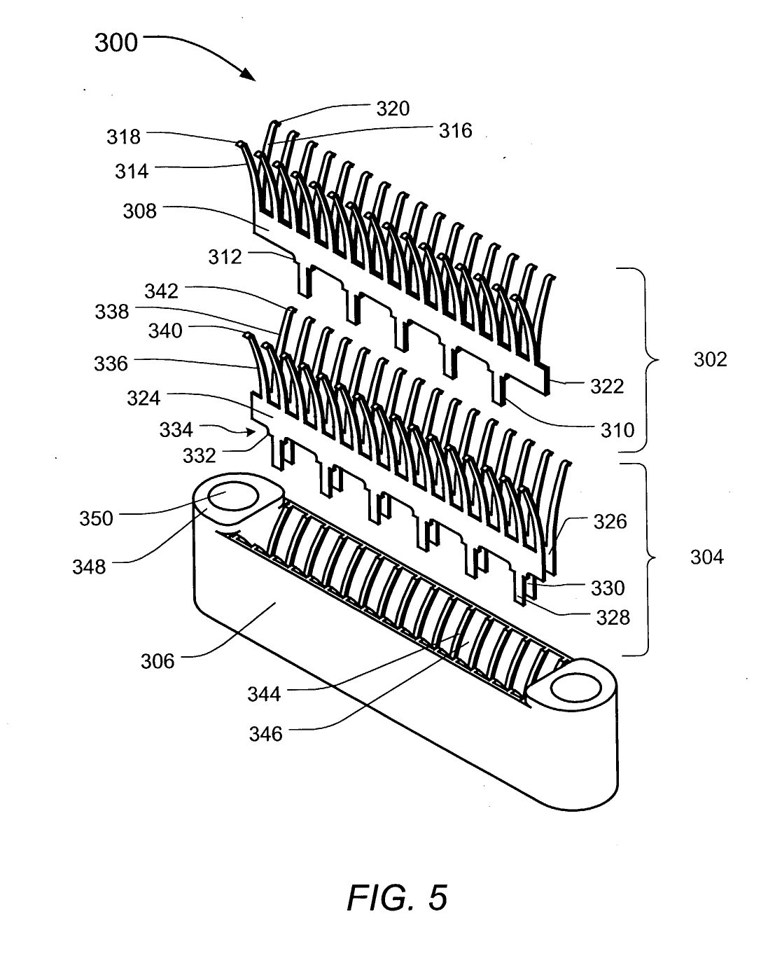

FIG. 5 is an isometric exploded view of a linear power connector assembly 300. The linear power connector assembly 300 includes a subassembly power array 302, a subassembly ground array 304, and a housing 306.

The housing 306 includes a spacer and landing zone 348, curvilinear support regions 344, 346, and retention or mounting holes 350. The outer housing 306 has a generally rectangular shape with two parallel inner surfaces. Once assembled, the subassembly power array 302 and the subassembly ground array 304 are located between the two inner surfaces of the housing 306. Each inner surface of the outer housing 306 has a tapering shape that includes convex and concave features which together form the curvilinear support regions. A convex feature is a curved or rounded outward portion of the inner surface. A concave feature is a hollowed or rounded inward portion of the inner surface. As illustrated in FIG. 5, these concave and convex features are alternately spaced along each inner surface of the housing 306. The concave features are in the form of grooves 346 in the inner surfaces. Located between two adjacent grooves 346 on each inner surface is the convex feature or land 344. For each inner surface, the lands 344 extend in a direction parallel to the grooves 346 in that inner surface to divide two adjacent grooves 346 and thereby form a buffer region therebetween. The concave features form valleys while the convex features form peaks or ridges along the inner surfaces of the housing 306. Together, the grooves 346 and lands 344 for each inner surface provide a single-level curvilinear support on that inner surface to control the mechanical actuation and travel for the subassembly power array 302 and the subassembly ground array 304. In this embodiment, the grooves 346 in both inner surfaces control the mechanical actuation and travel of the subassembly ground array 304 and the subassembly power array 302. The lands 344 provide the buffer region between each of the grooves 346. In this way, the housing 306 encases both the subassembly ground array 304 and the subassembly power array 302.

Alternatively, the curvilinear support regions 344, 346 have a different shape. For example, the curvilinear support regions 344, 346 could be flat. Alternatively, the housing 306 does not include the curvilinear 344, 246 support regions. In such an embodiment, the housing 306 acts as a mechanical structure for temporarily holding the conductors rather than providing a mechanical actuation mechanism.

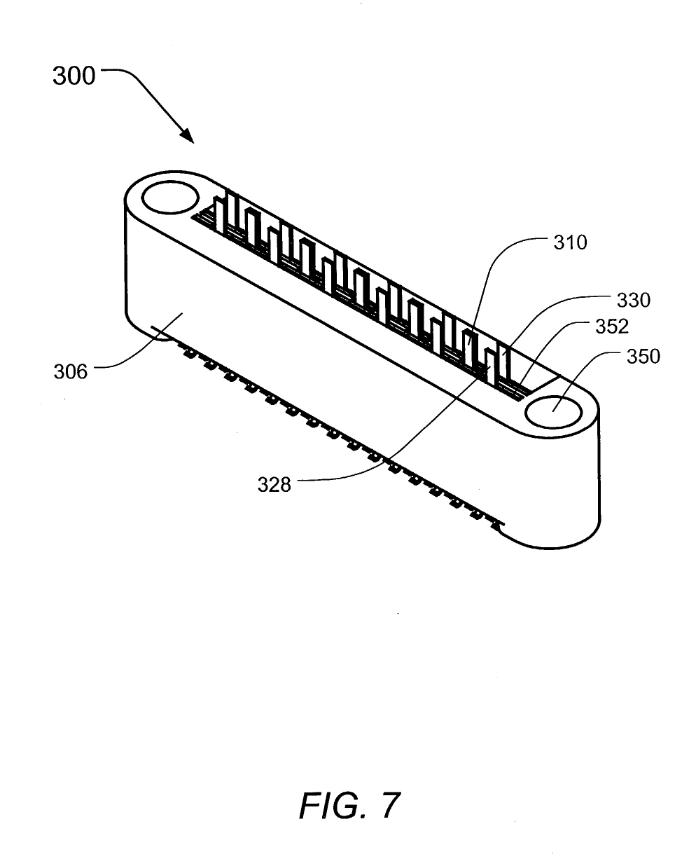

The spacer and landing zones 348 provides a gap between the first and second PCBs. The spacer and landing zones 348 limit compression of the linear power array 308 and the linear ground arrays 324, 326 between the first and second PCBs. Note that no additional dielectric member is shown between the linear power array 308 and the linear ground arrays 324, 326. An additional dielectric is not required because the separation between the linear power array and linear ground arrays is achieved within the housing 306 by alignment of the tab sections 310, 328, 330, into their respective holes or slots 352 in the housing (see FIG. 7). The holes or slots 352 are formed between walls within the housing. For example, two parallel walls could form three separate slots in the housing. Each of the three slots could accommodate an array of tab sections 310, 328, 330. Alternatively, a grid like pattern of walls could be used to form holes for each tab of each tab section. The physical space between the array of tab sections 310, 328, 330 act as a dielectric. The retention or mounting holes 350 are located at opposite ends of the housing 306. The retention or mounting holes 350 provide conduits for insertion of fasteners through the housing 306 which connect the first PCB to the second PCB. Note that other means may be used to mount and align the PCBs with the linear power connector assembly 300. For example, a boss or stud could be located beyond the outer surface of the housing 306 to form an alignment feature between the PCBs and the housing.

The subassembly power array 302 includes a linear power array 308. The linear power array 308 includes tab sections 310, power standoff section 312, beams or power contacts 314, 316, and power contact points 318, 320. The subassembly power array 302 has a linear like body with the power contacts/beams 314, 316 and tab sections 310 extending in substantially opposite directions therefrom. In the embodiment illustrated in FIG. 5, the power contacts 314, 316 emanate from a single flat conductor. In this embodiment, the linear power array 308 is made from a unitary member. Alternatively, the linear power array 308 is assembled from two members. By assembling the linear power array 308 from two members, the subassembly power array 302 can be separated to facilitate manufacture and assembly. For example, the linear power array 308 may include a pair of separate linear arrays secured permanently along a joint 322. Alternatively, the linear power array 308 may include a pair of linear arrays separated by a fixed distance within the housing 306.

The power contacts or beams 314, 316 extend from one side of the conductor and bend away from each other in an opposing fashion to form a first row of power contacts 314 and a second row of power contacts 316. The first row of power contacts 314 can be a mirror image of the second row of power contacts 316. The beams 314, 316 follow a curvilinear path and extend in a direction towards the first PCB. The tab sections 310 follow a linear path and extend in the opposite direction towards the second PCB. As with the signal contacts 108 previously described, this curved shape allows the beams 314, 316 to bend as the power contact points 318, 320 on the ends of the beams are brought in contact with the first PCB. In this way, the first PCB applies a compressive load to the contact points 318, 320 which bends the beams 314, 316. This bending occurs during assembly of the linear power connector assembly 300 with the first PCB. Since the electrical connection between the contact points 318, 320 and the first PCB is not coupled in a permanent manner, the first PCB and linear power connector assembly 300 can be disassembled. In this way, the contact points 318, 320 are separable from the first PCB.

The power contact points 318, 320 are located at the distal ends of the beams or power contacts 314, 316. The power contact points 318 are located at the ends of the power contacts 314. The power contact points 320 are located at the end of the power contacts 316. The power contact points 318, 320 mate with contact pads of a first PCB when brought in contact with the first PCB. The contact pads which mate with the power contact points 318 are arranged in a substantially linear fashion on the surface of the first PCB. The contact pads which mate with the power contact points 320 are arranged in a substantially linear fashion on the surface of the first PCB. The contact pads that mate with the power contact points 320 are arranged on the surface of the first PCB in parallel with respect to the contact pads that mate with the power contact points 318.

The tab sections 310 emanate from a side of the single flat conductor that is substantially opposite from the power contacts 314, 316 side. During installation into the housing 306, the tab sections 310 are inserted through the housing and contact a second PCB. The tab sections 310 couple to the second PCB. This coupling can be permanent in nature in that the second PCB and the subassembly power array 302 can form a solder joint. For example, the tab section 310 could be press-fit soldered to the second PCB. Alternatively, the connection between the second PCB and the subassembly power array 302 is a press-fit connection. With the tab sections 310 contacting the second PCB, the subassembly power array 302 forms an electrical path between the first and second PCBs.

The beams or power contacts 314, 316 fit within the grooves 346 in the housing 306. The beams 314, 316 are free to move into and out of the grooves 346 in response to pressure being applied to the power contact points 318, 320. However, the depths of the grooves 346 limit the maximum travel of the beams 314, 316. Similarly, the widths of the grooves 346 can limit movement of the beams 314, 316 in a direction towards the adjacent land 344. For example, when adequate pressure is applied to the ground contact points 318 so that the beams 314 are in the grooves 346, movement towards one side is limited by the adjacent land 344. In this way, the grooves 346 limit the actuation and travel of the power contacts 314, 316 during assembly of the linear power connector assembly 300 with the first PCB. Alternatively, the curvature of the beams 314, 316 of the linear power array 308 is increased so that the beams fall within the grooves 346 when the beams are in an uncompressed state.

The ground standoff sections 312 create landing zones or ridges at the intersections of the tab sections 310 with the linear like body of the linear power array 308. These landing zones increase the width of the tab sections 310 at the intersection of the tab sections with the linear like body so that when the linear power array 308 is inserted into the second PCB, a correct insertion depth is maintained. This correct insertion depth of the tab section 310 is achieved when the ridges or landing zones rest upon the surface of the second PCB.

The subassembly ground array 304 can include linear ground arrays 324, 326. The linear ground arrays 324, 326 may be similar to each other in that one can be a mirror image of the other. The linear ground arrays 324, 326 have linear like bodies with the ground contacts/beams 336, 338 and tab sections 328, 330 extending, respectively, in substantially opposite directions therefrom. In the embodiment illustrated in FIG. 5, the ground contacts 336, 338 emanate from two flat conductors.

The ground contacts or beams 336, 338 extend from one side of each of the conductors and bend away from each other in an opposing fashion to form a first row of ground contacts 336 and a second row of ground contacts 338. The first row of ground contacts 336 can be a mirror image of the second row of ground contacts 338. The beams 336, 338 follow a curvilinear path and extend in a direction towards the first PCB. The tab sections 328, 330 follow a linear path and extend in opposite directions towards the second PCB. As with the signal contacts 108 previously described, this curved shape allows the beams 336, 338 to bend as the ground contact points 340, 342 on the ends of the beams are brought in contact with the first PCB. In this way, the first PCB applies a compressive load to the contact points 340, 342 which bends the beams 336, 338. This bending occurs during assembly of the linear power connector assembly 300 with the first PCB. Since the electrical connection between the contact points 340, 342 and the first PCB is not coupled in a permanent manner, the first PCB and linear power connector assembly 300 can be disassembled. In this way, the contact points 340, 342 are separable from the first PCB.

The ground contact points 340, 342 are located at the distal ends of the beams or ground contacts 336, 338. The ground contact points 340, 342 are located at the ends of the ground contacts 336, 338, respectively. The ground contact points 340, 342 mate with contact pads of a first PCB when brought in contact with the first PCB. The contact pads which mate with the ground contact points 340 are arranged in a substantially linear fashion on the surface of the first PCB. The contact pads which mate with the ground contact points 342 are arranged in a substantially linear fashion on the surface of the first PCB. The contact pads that mate with the ground contact points 342 are arranged on the surface of the first PCB in parallel with respect to the contact pads that mate with the ground contact points 340.

The tab sections 328, 330 emanate from sides of the flat conductors that are substantially opposite from the ground contacts 336, 338 sides. During installation of each linear ground array 324, 326 into the housing 306, the tab sections 328, 330 are inserted through the housing and contact a second PCB, respectively. The tab sections couple to the second PCB. This coupling can be permanent in nature in that the second PCB and the linear ground arrays 324, 326 can form a solder joint. For example, the tab section could be press-fit soldered to the second PCB. Alternatively, the connection between the second PCB and the linear ground arrays 324, 326 is a press-fit connection. With the tab sections contacting the second PCB, each of the linear ground arrays 324, 326 forms an electrical path between the first and second PCBs.

The beams or ground contacts 336, 338 fit within the grooves 346 in the housing 306. The beams 336, 338 are free to move into and out of the grooves 346 in response to pressure being applied to the ground contact points 340, 342. However, the depths of the grooves 346 limit the maximum travel of the beams 336, 338. Similarly, the widths of the grooves 346 can limit movement of the beams 336, 338 in a direction towards the adjacent land 344. For example, when adequate pressure is applied to the ground contact points 340 so that the beams 336 are in the grooves 346, movement towards one side is limited by the adjacent land 344. In this way, the grooves 346 limit the actuation and travel of the ground contacts 340, 342 during assembly of the linear power connector assembly 300 with the first PCB. Alternatively, the curvature of the beams 336, 338 of the linear ground arrays 324, 326 is increased so that the beams fall within the grooves 346 when the beams are in an uncompressed state.

The ground standoff sections 332, 334 create landing zones or ridges at the intersections of the tab sections 328, 330 with the linear like body of the linear ground arrays 324, 326. These landing zones increase the width of the tab sections 328, 330 at the intersection of the tab sections with the linear like body so that when the linear ground arrays 324, 326 is inserted into the second PCB, a correct insertion depth is maintained. This correct insertion depth of the tab section 328, 330 is achieved when the ridges or landing zones rest upon the surface of the second PCB.

The subassembly power array 302 previously described, may include two arrays that are similar to the linear ground arrays 324, 326 rather than a single linear power array 308. This alternate two-part subassembly power array 302 can be assembled from two separate arrays as previously mentioned. Continuing with this alternate embodiment, the new subassembly power array 302 may be shifted over one contact with respect to the contacts of the linear ground arrays 324, 326 in the final assembly so that the contact points of the power and ground arrays are not aligned with one another.

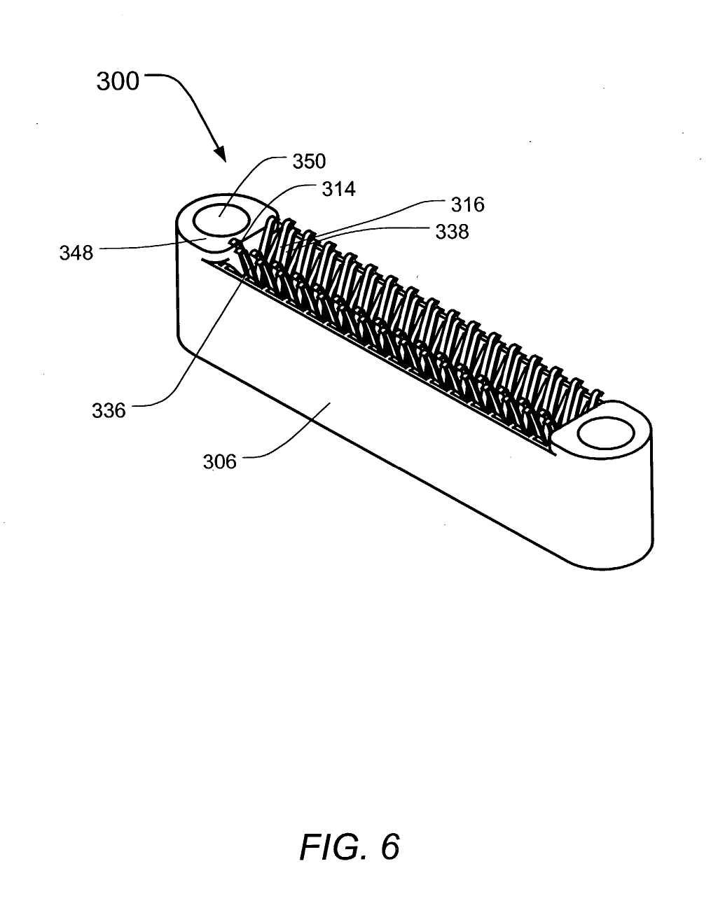

FIG. 6 is an isometric assembly view of the linear power connector assembly 300 from FIG. 5. With reference to FIGS. 5 and 6, the linear power connector assembly 300 is assembled by inserting the subassembly power array 302 and the subassembly ground array 304 into the housing 306 as shown in FIG. 6. Once assembled, the linear power connector assembly 300 forms a unitary compact assembly.

Upon assembly, the ground contacts 338 and power contacts 316 are arranged in an inter-digitated manner in the linear power connector assembly 300. Inter-digitated means at least one ground contact 338 is located between two power contacts 316 or at least one power contact is located between two ground contacts along the inner surface of the housing 306. Similarly, the ground contacts 336 and power contacts 314 are arranged in an inter-digitated manner in the linear power connector assembly 300. Inter-digitated means at least one ground contact 336 is located between two power contacts 314 or at least one power contact is located between two ground contacts along the other inner surface of the housing 306. By inter-digitating the power contacts and the ground contacts, the impedance and inductance for the power/ground portion of the linear power connector assembly 300 is reduced.

During assembly, the grooves 346 provide support for the ground contacts 336, 338 as the ground contact points 340, 342 are compressed against the first PCB, respectively. The grooves 346 further provide support for the power contacts 314, 316 as the power contact points 318, 320 are compressed against the first PCB, respectively. Once assembled with the first and second PCBs, each of the four rows of ground contacts 336, 338 and power contacts 314, 316 each contact the first PCB along different parallel and linear contact regions. In the embodiment of FIG. 6, the contact regions for the ground contacts 336, 338 are located outside of the contact regions for the power contacts 314, 316. However, it need not be so. The rows of power contacts 314, 316 could be arranged outside of the rows of ground contacts 336, 338. Alternatively, the beams 336, 338 for the ground contacts 324, 326 can have less curvature than the beams 314, 316 for the power contacts 314, 316. In this alternate embodiment, power contacts 314, 316 and the ground contacts 324, 326 could actuate similar distances towards the grooves 346.

FIG. 7 is an isometric bottom view of the linear power connector 300 from FIG. 6. The tab sections 328, 330, which are part of the linear ground arrays 324, 326, respectively, are shown separated from each other. The tab sections 328, 330 for each array fit within a slot or hole 352 in the housing 306. The tab section 310, which is part of the single or multi-piece linear power array 308, is shown joined together. As previously mentioned, other embodiments of the tabs, solder, or press-fit leads 310, 328, 330 may be envisioned. For example, the tab section 310 may be two tab sections.

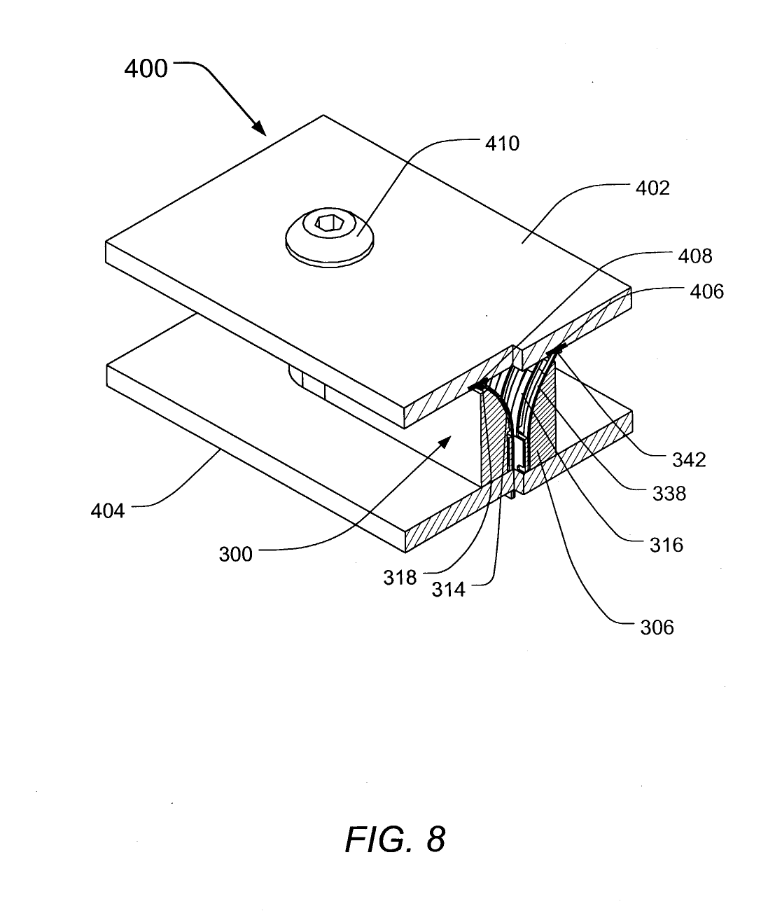

FIG. 8 is a cutaway isometric assembly view of the linear power connector 300 from FIG. 6 located between a first printed circuit board and a second printed circuit board thereby forming a PCB and connector assembly 400. The PCB and connector assembly 400 includes a first PCB assembly 402, a second PCB assembly 404, a linear power connector assembly 300, and a fastener 410. In the embodiment illustrated in FIG. 8, the linear power connector assembly 300 is easily separated from the first PCB assembly 402 via the fastener 410. In contrast, the linear power connector assembly 300 is not separable from the second PCB assembly 404.

The linear power connector assembly 300 is mounted between the first PCB assembly 402 and the second PCB assembly 404. In one embodiment, one end of the linear power connector assembly 300 is first fixedly attached to the second PCB assembly 404. Then, the first PCB assembly 402 is brought into mating contact with the opposite end of the linear power connector assembly 300. The fastener 410 maintains the mating contact between the linear power connector assembly 300 and the first PCB assembly 402. Alternatively, one end of the linear power connector assembly 300 is initially and temporarily assembled to the second PCB assembly 404. The first PCB assembly 402 is then brought into mating contact with the linear power connector assembly 300. The fastener 410 maintains the mating contact between the first PCB assembly 402 and the second PCB assembly 404. The linear power connector assembly 300 is then permanently attached to the second PCB assembly 404, via, for example, solder.

Depending on the embodiment, the fastener 410 can apply a compressive load to the PCB and connector assembly 400 via engagement with the linear power connector assembly 300 and the first PCB assembly 402 or via engagement with the first and second PCB assemblies 402, 404. In one embodiment, the fastener 410 couples the first PCB assembly 402 to the second PCB assembly 404. This could be accomplished by, for example, allowing the fastener 410 to pass through but not engage the linear power connector assembly 300. In this embodiment, the fastener 410 applies a compressive load to the linear power connector assembly 300 via engagement with the first and the second PCB assemblies 402, 404. The engagement with the first and second PCB assemblies 402, 404 can be accomplished by, for example, the head of the fastener 410 bearing on the surface of the first PCB assembly 402 with the other end of the fastener engaging threads in the second PCB assembly 404. Alternatively, the fastener 410 includes a second head on the opposite end of the fastener which bears on a surface of the second PCB assembly 404. In this embodiment, the compressive load is still achieved without the fastener 410 engaging threads in the second PCB assembly 404.

Alternatively, the fastener 410 couples the first PCB assembly 402 to the linear power connector assembly 300. In this embodiment, the fastener 410 applies a compressive load to the first PCB assembly 402 via engagement with the first PCB assembly and the linear power connector assembly 300. In this embodiment, the fastener 410 is not required to engage with the second PCB assembly 404 since the fastener engages with the linear power connector assembly 300. The engagement with the first PCB assembly 402 and the linear power connector assembly 300 can be accomplished by, for example, the head of the fastener 410 bearing on the surface of the first PCB assembly 402 with threads on the body of the fastener engaging threads in the linear power connector assembly 300. The compressive load is achieved without the fastener 410 engaging with the second PCB assembly 404. Embodiments, where the fastener 410 engages with one or more of the first and second PCB assemblies 402, 404 and the linear power connector assembly 300 is also contemplated and is clearly an aspect of the invention.

The first PCB assembly 402 includes two rows of contact pads 406, 408 located on the underside of the first PCB assembly. Each row of contact pads 406, 408 includes power contacts (not shown) and ground contacts (not shown). The power contacts and the ground contacts are arranged in a linear fashion on the surface of the PCB. This arrangement aligns each row of the power contacts on the PCB with the power contacts 314, 316 and aligns each row of the ground contacts on the PCB with the ground contacts 336, 338, respectively. In this way, each of the contact pads 406, 408 individually mates with a power contact 314, 316 or a ground contact 336, 338.

Fastener 410, which may be a screw or some other mechanical fastener, is secured to the lower PCB 404. It should be noted that there are typically two or more fasteners 410 for each PCB and connector assembly 400. The two or more fasteners 410 may be placed in an arrangement to minimize warping or deflection of the printed circuit boards. Those skilled in the art can envision other methods, such as external fasteners, which may be used to fasten the upper PCB assembly 402 to the lower PCB assembly 404.

The fastener 410 can be secured to a retention device located within the lower PCB 404 or located on the backside of the lower PCB assembly 404. In this way, the fastener compresses the upper PCB assembly 402 against the power contacts 314, 316 and the ground contacts 336, 338 of the linear power connector assembly 300. The power contacts and the ground contacts are compressed to a known height and set by the spacer and landing zones 348 of the linear power connector assembly 300. The travel of the power contacts 314, 316 and the ground contacts 336, 338 is further limited by the grooves 346 of the curvilinear support. As shown in FIG. 8, the housing 306 and spacer and landing zones 348 contact both the first PCB assembly 402 and the second PCB assembly 404. However, contact between the housing 306 and spacer and landing zones 348 and one or more of the PCBs is not required as long as the power contacts 314, 316 and the ground contacts 336, 338 are in contact with the first PCB assembly 402.

The second PCB assembly 404 includes plated through holes (not shown). The plated through holes are configured to receive the tabs of the power contacts and the ground contacts. In the illustrated embodiment, the plated through holes are arranged in lines on the surface of the second PCB assembly 404 and sized to receive the tabs 310, 328, 330.

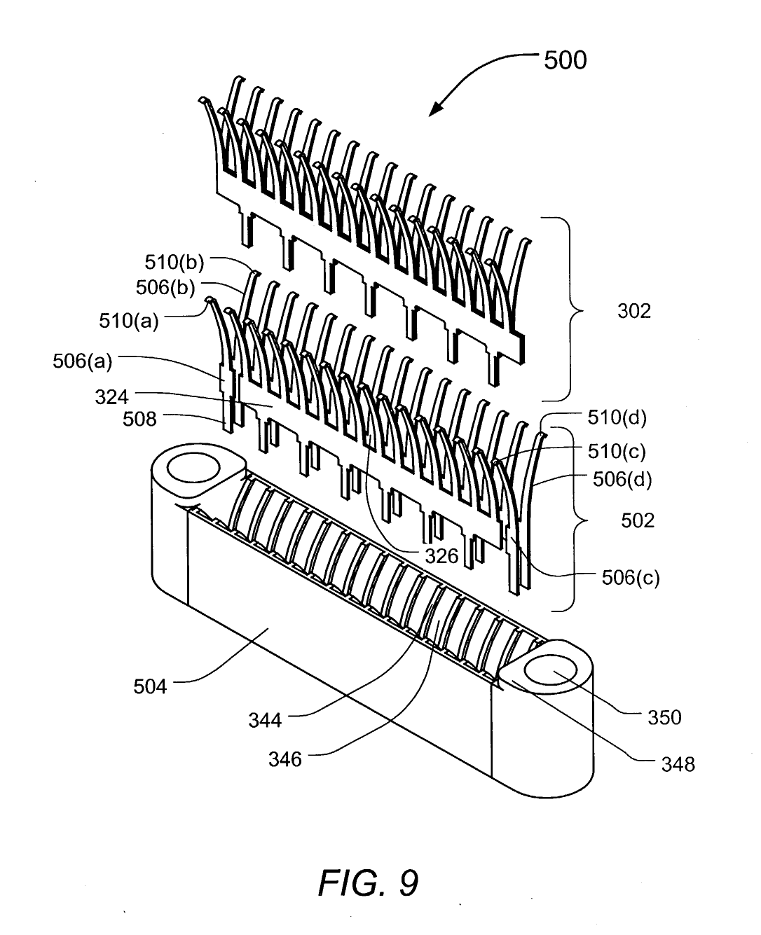

FIG. 9 is an isometric exploded view of a linear power and signal connector 500. The linear power and signal connector assembly 500 includes both power and signal contacts. The linear power and signal connector assembly 500 includes a subassembly power array 302, a subassembly signal and ground array 502, and a housing 504. The linear power and signal connector assembly 500 is similar to the linear power connector assembly 300, but additionally includes signal contacts 506.

The subassembly power array 302 is the same as previously described with reference to FIG. 5.

The subassembly signal and ground array 502 includes linear ground arrays 324, 326 and signal contacts 506(A)-(D). Each signal contact 506 further includes a tab section 508 and a contact point 510. The linear ground arrays 324, 326 are as described with reference to FIG. 5. The signal contacts 506 are shown as being located at both ends of each of the linear ground arrays 324, 326. However, as would be obvious to one of skill in the art, the signal contacts 506 could be located at other locations within the linear ground arrays 324, 326.

As shown in FIG. 9, the signal contacts 506(A)-(D) are adjacent to but not in contact with their respective linear ground arrays 324, 326. In this way, the linear power and signal connector assembly 500 provides connectivity for separate signals between the PCBs.

The housing 504 is similar to the housing 306 described with reference to FIG. 5. However, the housing 504 is constructed so as to maintain a gap between the signal contacts 506 and the linear ground arrays 324, 326. As in the linear power connector housing 306, the housing 504 has curvilinear support regions 344, 346. The grooves 346 in the curvilinear support regions support the power contacts 314, 316, the ground contacts 336, 338, and the signal contacts 506. The lands 344 control movement by the power contacts 314, 316, the ground contacts 336, 338, and the signal contacts 506 in a perpendicular to the actuation direction. The holes or slots 352 in the housing 504 provide separation between the power array 302, the linear ground arrays 324, 326, and the signal contacts 506 by aligning with the tab sections for each array. The housing 504 further includes retention or mounting holes 350 and spacer and landing zones 348 for mechanical retention and alignment.

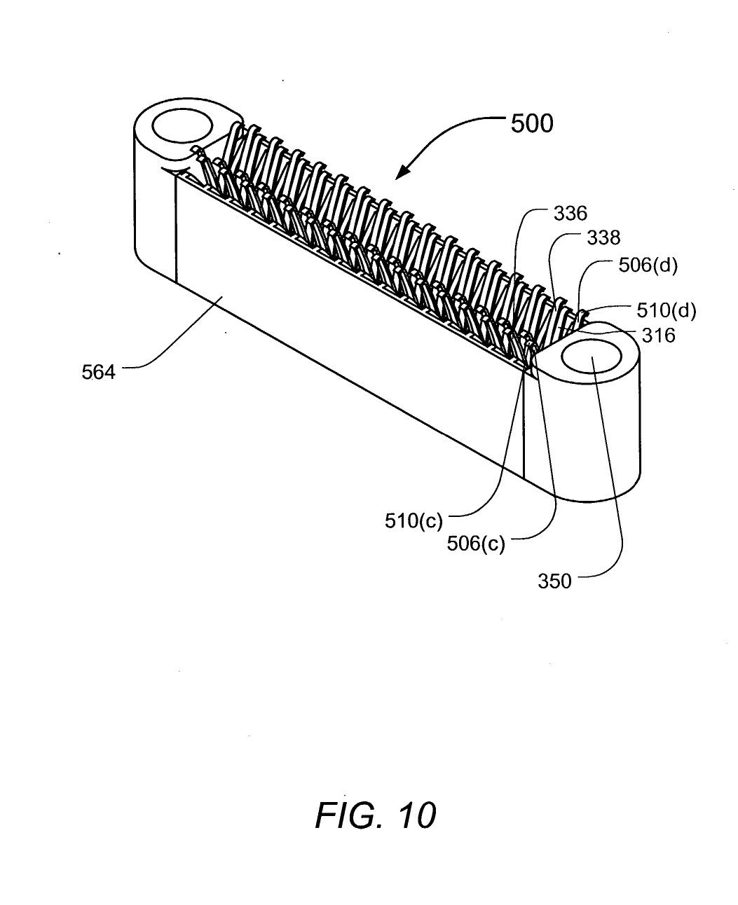

FIG. 10 is an isometric assembly view of the linear power/signal connector from FIG. 9. The power contacts 316 and the ground contacts 338 are inter-digitated for lower impedance in the linear power and signal connector assembly 500. Signal contact 506(D) is shown also inter-digitated but need not be so. The housing 504 is configured to keep the signal contacts 506 and the linear ground arrays 324, 326 separated. This separation mitigates the need for a separate dielectric between them. While only signal contacts 506(A)-(D) are shown in FIGS. 9 and 10, those skilled in the art can envision that placement and quantity of signal contacts 506, linear ground arrays 324, 326, and the subassembly power array 302 may be changed as necessary.

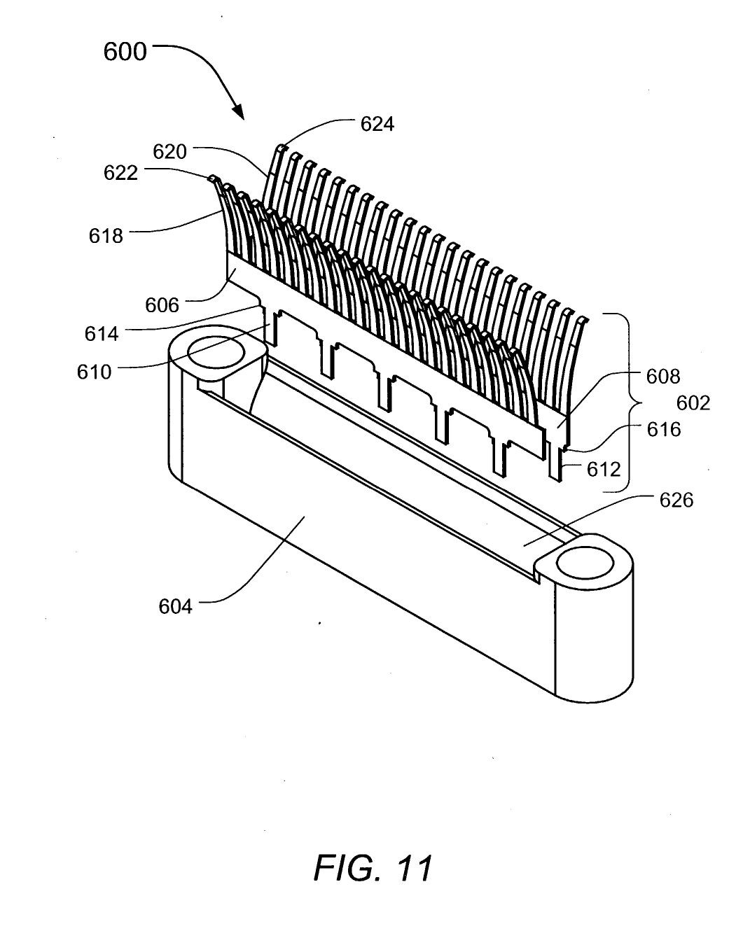

FIG. 11 is an isometric exploded view of another embodiment of a linear power connector. The linear power connector assembly 600 includes a subassembly power and ground array 602 and a housing 604. The subassembly power and ground array includes a linear power array 606 and a linear ground array 608. The linear power array 606 includes a tab section 610, a power standoff section 614, power contacts 618, and power contact point 622. The linear ground array 608 includes a tab section 612, a ground standoff section 616, ground contact 620, and ground contact points 624.

The linear power array 606 and the linear ground array 608 are similar to the subassembly ground array 304 described with reference to FIG. 5 except that the subassembly ground array 304 provides only a ground connection while the subassembly power and ground array 602 of FIG. 11 provides ground and power connections. In this way, the linear power array 606 and the linear ground array 608 provide conductivity for power and ground signals respectively.

The housing 604 includes mounting and retaining features similar to the previous embodiments. However, the housing 604 includes a single curvilinear support region 626 in lieu of the grooves and lands of the curvilinear support regions 344, 346 (see FIG. 5). Each side of the housing 604 has a similar curvature in contrast to the alternating curvatures of the grooves and the lands shown in FIG. 5. This is because the power contacts 618 and the ground contacts 620 actuate separately against an inner surface of the housing 604. Since the ground and power contacts actuate about the same axis, there is no need for inter-digitizing within the housing.

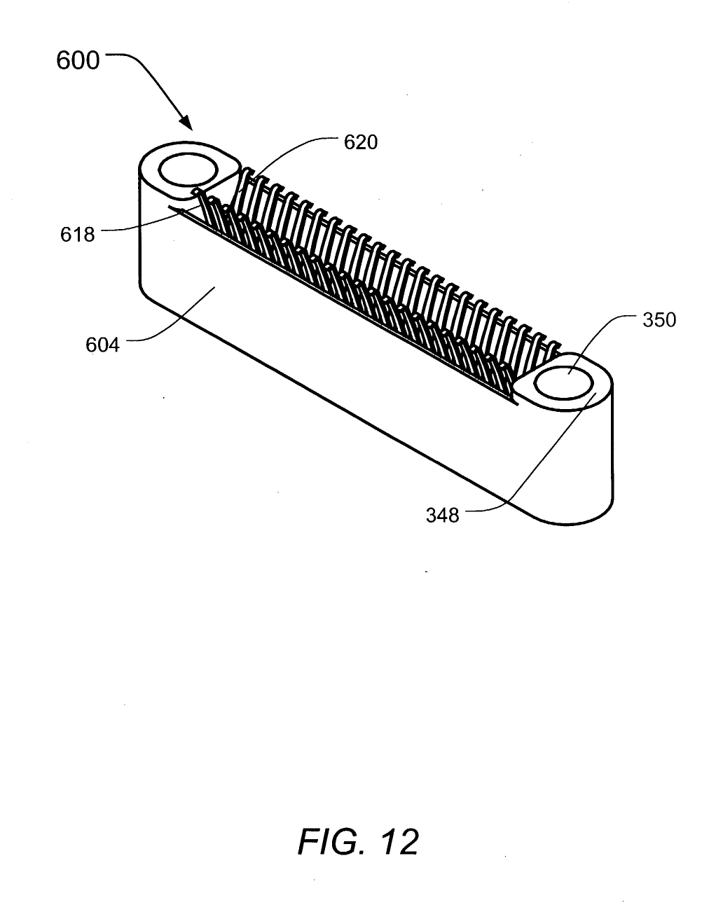

FIG. 12 is an isometric assembly view of the linear power connector from FIG. 11. The ground contacts 620 and the power contacts 618 actuate away from each other, which is different than shown in FIG. 5. In FIG. 5, the adjacent pairs of linear contacts with opposite polarities actuate in the same direction towards one of the inner surfaces of the housing 306. Because the contacts on each linear power array 606 and linear ground array 608 are shown springing outward from each other, an increase in impedance can occur. This increase in impedance can result in a lower performance of the linear power connector assembly 600 relative to that of other embodiments. However, the mechanical simplicity of the linear power connector assembly 600 is advantageous. For example, the power contacts 618 and the ground contacts 620 may be designed with a wider Z-axis travel in mind since the contacts do not interfere with each other. Further embodiments of the linear power connector assembly 600 can arrange the power contacts 618 and the ground contacts 620 to be inter-digitated so as actuate towards each other. Still another embodiment of the linear power connector assembly 600 can have the power contacts 618 and the ground contacts 620 inter-digitated while actuating towards one side or the other from both of the linear power array 606 and the linear ground array 608. Any of these embodiments, though not shown, would not limit the scope of the teachings in this description and may be applied to any one of the aforementioned linear connector embodiments for power and/or signal.

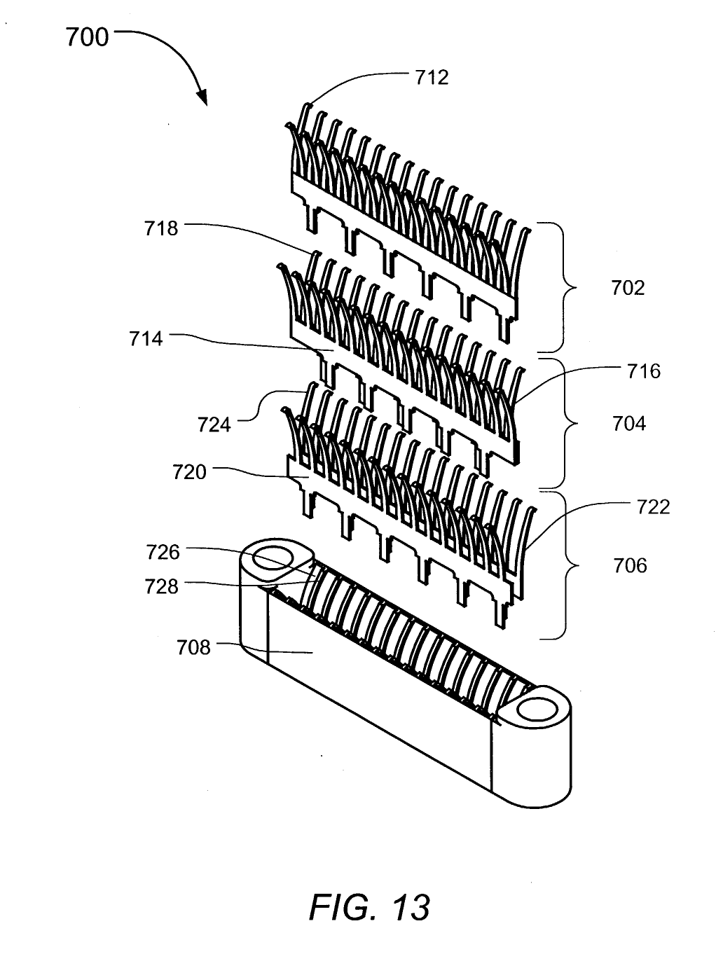

FIG. 13 is an isometric exploded view of another embodiment of a linear power connector. The linear power connector 700 includes a subassembly ground array 706, a subassembly power array 704, and a linear ground array 702. Alternatively, the different arrays 702, 704, 706 can be assigned to power in some embodiments and to ground in other embodiments. For example, the linear array 702 could be used for power.

The subassembly power array 704 includes linear power arrays 714, 716. The subassembly ground array 706 includes linear ground arrays 720, 722.

The linear ground array 702 has ground contacts 712 arranged in an alternating fashion and bending away from each other. The linear ground array 702 would typically be assigned to a ground reference, but need not be so.

The linear power arrays 714, 716 of the subassembly power array 704 can be assigned to a positive voltage reference, but need not be so. The power contacts of the subassembly power array 704 are arranged in an alternating fashion.

The subassembly ground array 706 is similar to the previously described subassembly ground array 304 with reference to FIG. 5. The linear ground arrays 720, 722 can be assigned to a ground reference, but also need not be so. This embodiment of the linear power connector 700 is intended for higher density and higher performance applications as compared to the previously described embodiments.

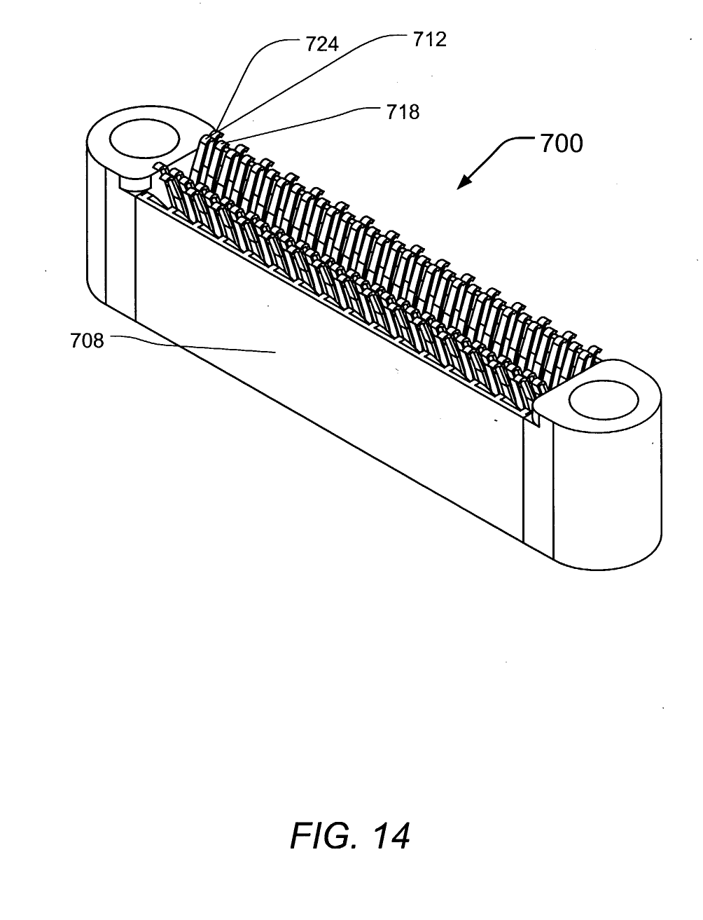

FIG. 14 is an isometric assembly view of an embodiment of the linear power connector from FIG. 13. The power contact 718 and the ground contact 724 are inter-digitated with each other. The ground contact 712 slightly overlaps both of the power contacts 718 and the ground contacts 724 for lower overall impedance. The ground contacts 724 and the power contacts 718 are supported during actuation by curvilinear features 726, 728 of housing 708 (see FIG. 13). However, the ground contacts 712 from the linear ground array 702 are not supported by the curvilinear features 726, 728. Thus, the power contacts 718 and the subassembly power array 704 have less travel than the ground contacts 712, 724.

Encapsulated Circuit Assembly

Typically, a modem high performance microprocessor die is flip-chip attached to an organic or ceramic substrate utilizing a Controlled-Collapse-Chip-Connection (C4). The substrate has power planes which are used to distribute power to the chip connections. Often the power requirements of the microprocessor exceed 100 watts at operating voltages of approximately 1 volt and transient current requirements in excess of 1000 amps per microsecond. Typically power conditioning is provided by a voltage regulation module (VRM). The stringent power demands require that the VRM be very closely coupled to the microprocessor or directly mounted on to the microprocessor substrate in which case this configuration is often called On-Package-Voltage-Regulation (OPVR). OPVR architectures require combining VRM technology with high performance silicon technology all on a common substrate which is often very expensive because of the very large number of layers required to manage both the power and signal interconnect to the microprocessor die. The resulting assembly is very expensive has reduced yield and higher costs than what might be achieved if the microprocessor function could be separated from the VRM function without reducing performance.

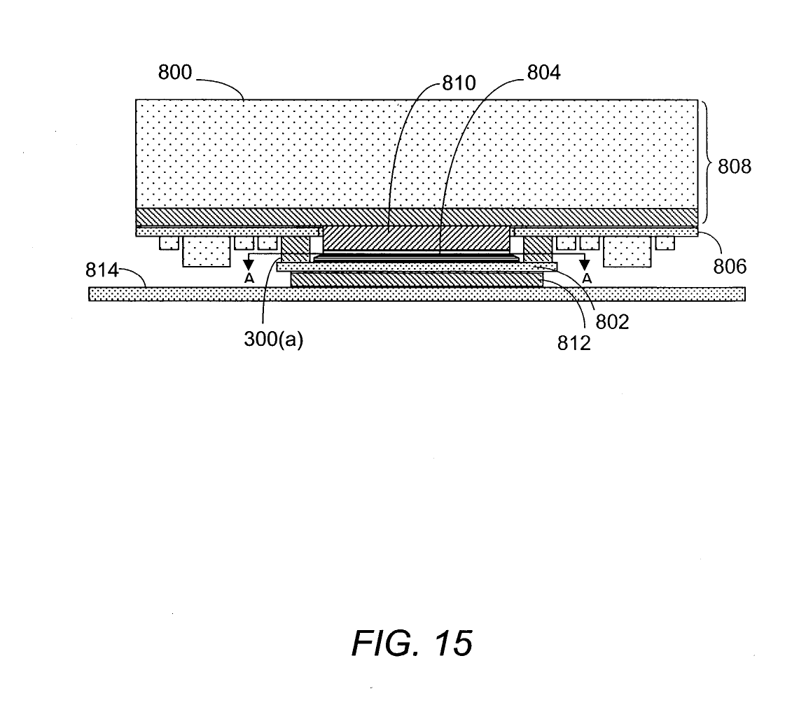

FIG. 15 is a diagram illustrating a stack up assembly 800 that includes a linear power connector assembly 300 to deliver power to a microprocessor substrate 802 and its associated lid 804 from a remotely located VRM assembly 806. In the illustrated embodiment, the VRM assembly 806 surrounds the microprocessor lid 804, thus saving space in the z (vertical) axis. The linear power connector assembly 300 can be used to electrically couple two printed circuit boards together, a printed circuit board with a microprocessor substrate, a printed circuit board with a microprocessor carrier, a printed circuit board with a lid of a microprocessor, or other desirable combinations of these components.

The microprocessor lid 804 is thermally coupled to a heatsink structure 808 through a thermal coupling mesa 810. This coupling can further include an appropriate thermal interface material (TIM) such as thermal grease (not shown). The thermal grease can be integral to the base of 810 or a separate structure that is coupled (i.e. bonded, or metallically fused) to the base of the heatsink structure 808. Furthermore, heat generated from components in the VRM assembly 806 can be thermally attached directly to the base of heatsink assembly 808, thus sharing the heat dissipation benefits of the heatsink assembly 808. Signals from the microprocessor can be connected through pins (not shown) to socket 812 which is mounted to main board 814.

Power from the VRM assembly 806 is efficiently coupled to the microprocessor substrate 802 by utilizing one or more coaxial and/or linear power connector assemblies. The stack up assembly 800 uses linear power connector assemblies 300. Alternatively, a coaxial power connector assembly could be used. In the embodiment illustrated in FIG. 15, four linear power connector assemblies 300(a)-(d) are each located proximate to a corner of the microprocessor substrate 802.

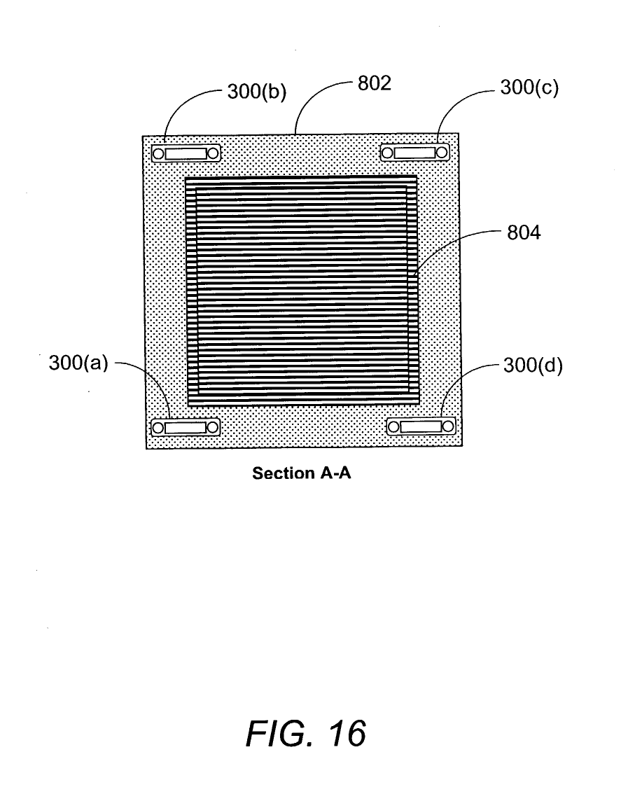

FIG. 16 is a diagram showing the location of the linear power connector assemblies 300(a)-(d) located proximate to the corners of the microprocessor substrate 802. The linear power connector assemblies 300(a)-(d) may be located in other locations on the substrate 802 such as at the center of each side. Further, the number of linear power connector assemblies 300(a)-(d) used can be varied to meet the power needs of target microprocessor or other high performance Integrated Circuit assembly.

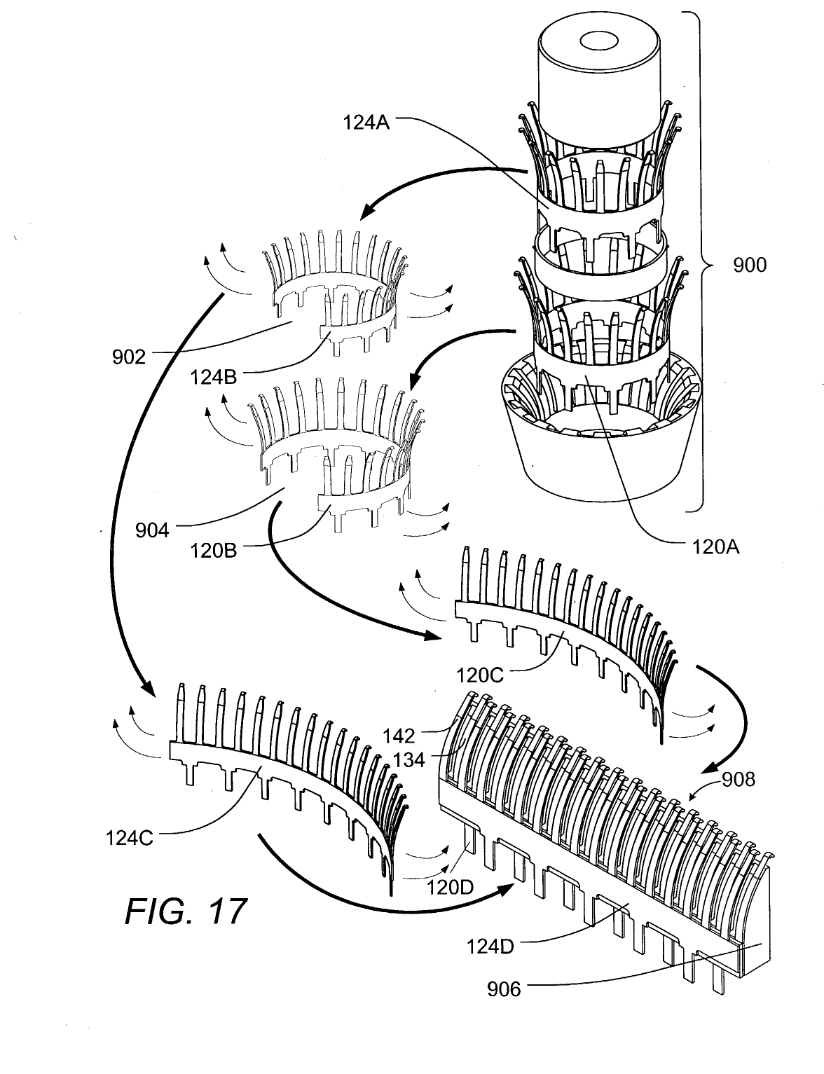

FIG. 17 is a conceptual isometric morphological progression of the coaxial power connector assembly 900 into a linear power connector assembly. Step A shows an exploded coaxial power connector assembly 900 that includes a coaxial power cylinder array 124A and a coaxial ground cylinder array 120A. Splits 902, 904 in both cylinders eliminate the concentricity of the cylinders 124B, 120B as shown in step B, respectively. Step C shows the unrolling of the cylinders now in forms 124C and 120C. Finally, step D shows the power signal array and the ground signal array in a partial assembly 908 where the beams 134, 142 have been mated in an inter-digitated fashion against a housing 906.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A connector suitable for electrically connecting a first printed circuit board to a second printed circuit board, the coaxial connector comprising:
a tubular housing having an inside surface;
a first cylinder located adjacent to the inside surface and having an array of ground contacts with a first array of tabs extending therefrom, the array of ground contacts and the first array of tabs extend in substantially opposite directions;
a second cylinder coaxially located within the first cylinder and having both an array of power contacts and a second array of tabs extending therefrom, the array of power contacts and the second array of tabs extend in substantially opposite directions from the second cylinder; and
a dielectric ring located between the first cylinder and the second cylinder.

2. The connector of claim 1, wherein the array of ground contacts and the array of power contacts are inter-digitated with one another.

3. The connector of claim 2, further comprising a center body section coaxially located within the second cylinder.

4. The connector of claim 3, wherein the center body section comprises a cavity section.

5. The connector of claim 4, further comprising a signal contact located in the cavity section.

6. The connector of claim 2, wherein the first cylinder further comprises a signal contact located around a circumference of the first cylinder, and wherein the array of ground contacts and the first array of tabs are electrically isolated from the signal contact.

7. The connector of claim 2, wherein the second cylinder further comprises a signal contact located around a circumference of the second cylinder, and wherein the array of power contacts and the second array of tabs are electrically isolated from the signal contact.

8. The connector of claim 2, wherein the inside surface of the tubular housing comprises a first curvilinear support region and a second curvilinear support region configured to limit movement of the array of ground contacts and the array of power contacts.

9. The connector of claim 8, wherein the first curvilinear support region limits movement of the array of ground contacts and the second curvilinear support region limits movement of the array of power contacts.

10. The connector of claim 1, wherein the first array of tabs and the second array of tabs are configured for attachment to a first printed circuit board.

11. The connector of claim 10, wherein the array of ground contacts and the array of power contacts are configured for attachment to a second printed circuit board.

12. The connector of claim 10, wherein the attachment between the first printed circuit board and the first and second arrays of tabs is permanent.

13. The connector of claim 12, wherein the attachment to the second printed circuit board is a solder joint.

14. The connector of claim 10, wherein the attachment to the second printed circuit board is a press-fit joint.

15. The connector of claim 11, wherein the array of ground contacts is separable from the second printed circuit board.

16. The connector of claim 15, wherein the array of power contacts is separable from the second printed circuit board.

17. The connector of claim 3, wherein the center body section comprises a bore for aligning the connector with a first printed circuit board for ease of assembly.

18. A linear connector configured to electrically connect a first printed circuit board to a second printed circuit board, the linear connector comprising:
a housing;
a receptacle extending into the housing and having a first inside surface and a second inside surface, a portion of the first inside surface is substantially parallel to a portion of the second inside surface;
a first linear ground array extending into the receptacle and located adjacent to the first inside surface, the first linear ground array having both a first array of ground contacts and a first array of tabs extending therefrom, the first array of ground contacts and the first array of tabs extend in substantially opposite directions from the first linear ground array;
a second linear ground array extending into the receptacle and located adjacent to the second inside surface, the second linear ground array having both a second array of ground contacts and a second array of tabs extending therefrom, the second array of ground contacts and the second array of tabs extend in substantially opposite directions from the second linear ground array; and
a linear power array extending into the receptacle and located between the first linear ground array and the second linear ground array, the linear power array having a first row of power contacts, a second row of power contacts, and a third array of tabs, all extending from the linear power array, the third array of tabs extending in substantially opposite directions from the first and second row of power contacts.

19. The connector of claim 18, wherein the housing further comprises a wall between a portion of the first linear ground array and a portion of the linear power array.

20. The connector of claim 19, wherein the housing further comprises a second wall member located between a portion of the second linear ground array and a portion of the linear power array.

21. The connector of claim 18, wherein the first array of ground contacts and the first row of power contacts are inter-digitated with one another.

22. The connector of claim 21, wherein the second array of ground contacts and the second row of power contacts are inter-digitated with one another.

23. The connector of claim 18, wherein the first inside surface of the housing comprises a first curvilinear support region and a second curvilinear support region configured to limit movement of the first array of ground contacts and the first row of power contacts.

24. The connector of claim 23, wherein the second inside surface of the housing comprises a third curvilinear support region and a fourth curvilinear support region configured to limit movement of the second array of ground contacts and the second row of power contacts.

25. The connector of claim 23, wherein the first curvilinear support region limits movement of the first array of ground contacts and the first row of power contacts.

26. The connector of claim 24, wherein the third curvilinear support region limits movement of the second array of ground contacts and the second row of power contacts.

27. The connector of claim 22, wherein the first, second, and third arrays of tabs are configured for attachment to a first printed circuit board.

28. The connector of claim 27, wherein the first and second arrays of ground contacts and the first and second rows of power contacts are configured for attachment to a second printed circuit board.

29. The connector of claim 27, wherein the attachment between the first printed circuit board and the first, second, and third arrays of tabs is permanent.

30. The connector of claim 29, wherein the attachment to the second printed circuit board is a solder joint.

31. The connector of claim 29, wherein the attachment to the second printed circuit board is a press-fit joint.

32. The connector of claim 28, wherein the first and second arrays of ground contacts are separable from the second printed circuit board.

33. The connector of claim 32, wherein the first and second rows of power contacts are separable from the second printed circuit board.

34. The connector of claim 21, further comprising a retention hole in the housing for aligning the connector to a first printed circuit board.

35. The connector of claim 34, further comprising a landing zone on a surface of the housing to abut the first printed circuit board thereto.

36. The connector of claim 22, further comprising a signal contact extending through the receptacle and located between the first row of power contacts and the first inside surface.

37. The connector of claim 36, further comprising a second signal contact extending through the receptacle and located between the second row of power contacts and the second inside surface, wherein the second row of power contacts and the third array of tabs are electrically isolated from the signal contact.

38. The connector of claim 18, wherein the first wall member, the second wall member, and the housing are formed from a unitary member.

39. The connector of claim 38, wherein the first wall member and the second wall member form a plurality of slots in the housing, each slot being configured to receive one of the first, second, and third arrays of tabs.

40. A linear connector configured to electrically connect a first printed circuit board to a second printed circuit board, the linear connector comprising:
a rectangular receptacle having a first inside surface and a second inside surface, a portion of the first inside surface is substantially parallel to a portion of the second inside surface;
a linear ground array extending through the receptacle and located adjacent to the first inside surface, the linear ground array having both an array of ground contacts and an array of ground tabs extending therefrom, the array of ground contacts and the array of tabs extend in substantially opposite directions from the linear ground array; and
a linear power array extending through the receptacle and located between the linear ground array and the second inside surface, the linear power array having an array of power contacts and an array of power tabs, both extending from the linear power array.

41. The connector of claim 40, wherein the first inside surface comprises a first groove configured to limit movement of the array of ground contacts.

42. The connector of claim 41, wherein the second inside surface comprises a second groove configured to limit movement of the array of power contacts.

43. The connector of claim 40, further comprising a dielectric member located between a portion of the linear ground array and a portion of the linear power array.

44. The connector of claim 43, wherein the dielectric member and the rectangular receptacle are formed from a unitary member.

45. The connector of claim 44, wherein the dielectric member forms a first slot and a second slot in the rectangular receptacle, the first slot being configured to receive the array of tabs, and the second slot being configured to receive the array of power tabs.

46. A linear connector configured to electrically connect a first printed circuit board to a second printed circuit board, the linear connector comprising:
a housing;
a rectangular receptacle extending into the housing and having a first inside surface and a second inside surface, a portion of the first inside surface is substantially parallel to a portion of the second inside surface;
a first linear ground array extending into the receptacle and located adjacent to the first inside surface, the first linear ground array having both a first array of ground contacts and a first array of tabs extending therefrom, the first array of ground contacts and the first array of tabs extend in substantially opposite directions from the first linear ground array;
a second linear ground array extending into the receptacle and located adjacent to the second inside surface, the second linear ground array having both a second array of ground contacts and a second array of tabs extending therefrom, the second array of ground contacts and the second array of tabs extend in substantially opposite directions from the second linear ground array;
a first linear power array extending into the receptacle and located adjacent to the first linear ground array, the first linear power array having both a first array of power contacts and a third array of tabs extending therefrom, the first array of power contacts and the third array of tabs extend in substantially opposite directions from the first linear power array;
a second linear power array extending into the receptacle and located adjacent to the second linear ground array, the second linear power array having both a second array of power contacts and a fourth array of tabs extending therefrom, the second array of power contacts and the fourth array of tabs extend in substantially opposite directions from the second linear power array;
a third linear ground array extending into the receptacle and located between the first linear power array and the second linear power array, the third linear ground array having a first row of ground contacts, a second row of ground contacts, and a fifth array of tabs, all extending from the third linear ground array, the fifth array of tabs is parallel to the first, second, third, and fourth arrays of tabs;
fifth array of tabs, all extending from the third linear ground array, the fifth array of tabs is parallel to the first, second, third, and fourth arrays of tabs;
a first wall member located between a portion of the first linear ground array and a portion of the first linear power array; and
a second wall member located between a portion of the second linear ground array and a portion of the second linear power array.
a third wall member located between a portion of the first linear power array and a portion of the third linear ground array; and
a fourth wall member located between a portion of the second linear power array and a portion of the third linear power array.

47. The connector of claim 46, wherein the first, second, third, and fourth wall members and the housing are formed from a unitary member.

48. The connector of claim 47, wherein the first, second, third, and fourth wall members form a plurality of slots in the housing, each slot being configured to receive one of the first, second, third, fourth, and fifth arrays of tabs.

49. A linear connector configured to electrically connect a first printed circuit board to a second printed circuit board, the linear connector comprising:
a housing;
a receptacle extending into the housing and having a first inside surface and a second inside surface, a portion of the first inside surface is substantially parallel to a portion of the second inside surface;
a first linear power array extending into the receptacle and located adjacent to the first inside surface, the first linear power array having both a first array of power contacts and a first array of tabs extending therefrom, the first array of power contacts and the first array of tabs extend in substantially opposite directions from the first linear power array;
a second linear power array extending into the receptacle and located adjacent to the second inside surface, the second linear power array having both a second array of ground contacts and a second array of tabs extending therefrom, the second array
a linear ground array extending into the receptacle and located between the first linear power array and the second linear power array, the linear ground array having a first row of ground contacts, a second row of ground contacts, and a third array of tabs, all extending from the linear ground array, the third array of tabs extending in substantially opposite directions from the first and second row of ground contacts.
